(19) United States
(12) Patent Application Publication
(10) Pub. No.: US 2018/0114168 A1
(43) Pub. Date: Apr. 26, 2018

(54) SYSTEM AND METHOD FOR DIGITAL SUPPLY CHAIN TRACEABILITY

(71) Applicant: Aglive International Pty Ltd, Highton, Melbourne, Victoria (AU)

(72) Inventor: John Paul Ryan, Newtown, Melbourne, VIC (AU)

(21) Appl. No.: 15/565,126

(22) PCT Filed: Apr. 8, 2016
(86) PCT No.: PCT/AU2016/050261

§ 371 Date: Oct. 6, 2017

Related U.S. Application Data
(60) Provisional application No. 62/144,544, filed on Apr. 8, 2015.

(51) Int. Cl. G06Q 10/06

(52) U.S. Cl. CPC G06Q 10/06315

(57) ABSTRACT

A method, comprising: receiving, by one or more computing devices, digital data about a physical object located at or between nodes in a physical supply chain, wherein the digital data is collected by and received from one or more digital devices without manual user-defined input; aggregating, by the one or more computing devices, the digital data into a digital data chain that is a digital representation of the physical object in the physical supply chain; providing, by the one or more computing devices, access to the digital data chain to verify one or more attributes of the physical object.

### CROSS-REFERENCE TO RELATED APPLICATIONS

This invention claims priority to and the benefit of PCT International Application No. PCT/AU2016/050261, entitled SYSTEM AND METHOD FOR DIGITAL SUPPLY CHAIN TRACEABILITY, filed on Apr. 8, 2016; which claims priority to and the benefit of U.S. Provisional Patent Application No. 62/144,544 filed on Apr. 8, 2015, both of which are incorporated by reference in their entireties.

### FIELD

The present invention relates to a system and method for digital supply chain traceability.

### BACKGROUND

Governments, suppliers, retailers and consumers are becoming increasingly concerned about the transparency, integrity and safety of supply chains across a wide range of industries. For example, supply chain traceability has become increasingly important in the food industry in the wake of several food safety and public health crises, and a number of high-profile food substitution and animal welfare scandals. Further, the rapid globalisation of trade threatens to increase the spread of plant and animal diseases among countries across the globe threatening the economic sustainability and biosecurity of food supply chains. Supply chain transparency and traceability have also recently emerged as priority issues in other industries, such as the hazardous goods, luxury goods, forestry and clothing industries, as governments, consumers and businesses alike have become increasingly concerned about public security and safety, counterfeiting, environmental sustainability, and labour conditions of workers in developing countries. For example, supply chain tracking and tracing is a major issue for controlled industries or goods, such as pharmaceuticals, where tracking and controlling the return or recall of ‘out of date’ drugs to manufacturers for safe disposal is required in the face of increased drug abuse and black market trade.

Existing supply chain traceability systems currently in use across different industries suffer from various drawbacks. Participants in many industries still use paper tracking and documentation which is not easily accessible or usable by other participants either upstream or downstream in the supply chain. As the amount of traceability data that is required to be collected and managed continues to expand across most industries, paper recordkeeping is increasingly being mandated by government and industry bodies to be replaced by digital recordkeeping.

However, from an end-to-end, whole supply chain perspective, a major barrier to the switch to paperless, digital-only tracing and recordkeeping is integration. Existing electronic traceability systems provide product identifiers under a One up, one down′ (OUOD) principle which requires each participant to retain origin data on their supplier and customer. This ‘data silo’ approach does not link the entire supply chain together and can only track origin on a piecemeal, historical basis when all individual data silos are interrogated and individual data is collated. Even if each individual participant in the supply chain collects and manages its own digital traceability data, ensuring complete digital traceability with full visibility for any one participant in the supply chain requires that different systems be able to communicate with each other. It is not enough to merely know which materials come from which node in the supply chain. Further, it is not enough to know which participant in the supply chain has traceability within its own system. Instead, full data visibility from one node to another in the supply chain requires each participant to have access to upstream data from at least two participants or nodes away and, ideally, the ability to trace a particular material all the way back to its origin. In addition, each supply chain participant must be able to provide that traceability data to downstream partners and nodes. Furthermore, existing GS1 barcoding merely statically identifies items at individual nodes in physical supply chains. Barcodes are incapable of providing dynamic geospatial data about date, time and location as the items move between and among nodes in physical supply chains, and they are also highly impractical for many agricultural supply chains. Similarly, existing approaches to monitoring and controlling biosecurity hazards rely on biosecurity codes that are statically allocated to individual farms. Again, existing biosecurity farm codes are incapable of providing dynamic geospatial data about date, time and location of animals as they move and are transported between and among different geographically dispersed nodes in physical supply chains.

The integration issue is further complicated by the length and complexity of supply chains. More heterogeneous nodes in the supply chain make traceability a more difficult issue. This is complicated even further by globalisation, with sourcing of raw ingredients from widely separated geographic locations. In addition, the more complex the supply chain is in terms of analysing a variety of materials into a mixed end-product at different links, the more difficult tracking and tracing visibility is.

Some sectors have proposed addressing the integration issue by establishing a large data depository where each supply chain participant reports into the same database using an industry-specific protocol that identifies a standard format for data storage. However, establishing a database with a standard data format and a common recordkeeping protocol that encompasses every type of material, industry and supply chain in every country is impractical.

In this context, there is a need for improved solutions for digital supply chain traceability.

### SUMMARY

According to the present invention, there is provided a method, comprising:

a. receiving, by one or more computing devices, digital data about a physical object located at or between nodes in a physical supply chain, wherein the digital data is collected by and received from one or more digital devices without manual user-defined data input;
b. aggregating, by the one or more computing devices, the digital data into a digital data chain that is a digital representation of the physical object in the physical supply chain;
c. providing, by the one or more computing devices, access to the digital data chain to verify one or more attributes of the physical object.

The method may further comprise tracking or tracing, by the one or more computing devices, the physical object along the physical supply chain in upstream and/or downstream directions based on the digital data chain.

The method may further comprise managing, by the one or more computing devices, the physical supply chain of the physical object based on the digital data chain.

The method may further comprise auditing, by the one or more computing devices, the physical supply chain to determine compliance or non-compliance of the physical object with regulations associated with the physical supply chain based on the digital data chain. For example, the regulations may relate to handling of the physical object, or drug testing or animal welfare when the physical object is an animal.

The method may further comprise determining, by the one or more computing devices, a break in the physical supply chain of the physical object based on detecting a break in the digital data chain. The method may further comprise generating, by the one or more computing devices, a digital alert upon detecting the break in the digital data chain.

The method may further comprise determining, by the one or more computing devices, an itinerary of the physical object along the physical supply chain, and detecting, by the one or more computing devices, a departure from the itinerary based on the digital data chain.

The method may further comprise detecting, by the one or more computing devices, one or more of a delay, a diversion, a substitution, a tampering, a chemical change, an environmental change, a temperature change, an alteration, a contamination, an adulteration, a misuse, a mishandling, an undersupply, an oversupply, a theft, an under-production, an over-production, an overheating, and a counterfeiting of the physical object along the physical supply chain based on the digital data chain.

The method may further comprise providing, by the one or more computing devices, a digital data snapshot of the physical object at or between each node in the physical supply chain based on the digital data chain.

The digital data may comprise objective digital data relating to properties, characteristics or attributes that are natural, unique or inherent in or to the physical object.

The objective digital data may comprise a digital fingerprint or certificate of location, quantity and quality of the physical object at or between each node in the physical supply chain. Further, the objective digital data may have a standardised data structure, protocol or format that is independent of any standardised data structure, protocol or format associated with the physical object or the physical supply chain. For example, the objective digital data may have a data structure, protocol or format that is standardised at the level of the one or more digital devices.

The objective digital data may comprise at least both of a time and an associated geographic location, and at least one of a unique identifier, an electronic identification number, an International Mobile Equipment Identity (IMEI) number, a radio frequency identification (RFID) number, a Property Identification Code (PIC), a serial number, a barcode, a Quick Response (QR) code, an alpha and/or numeric code, a Global Positioning System (GPS) signal, GPS journey data, a consignment note barcode, a waybill barcode, Geographic Information System (GIS) data, a nutritional composition, an elemental composition, a molecular composition, quantity, weight, volume, mass, density, age, health, a digital image, a blood profile, a drug profile, a drug test result, a genetic profile, a DNA profile, a chemical signature, a biochemical signature, a physical signature, a magnetic signature, an electrical signature, an optical signature, a luminescent signature, an infrared signature, an ultraviolet signature, a temperature, a humidity, a light reflectivity or absorption, an acoustic signature, a colour profile, an altitude, a geo-fence, a vaccination product, a vaccination status, and combinations thereof.

For example, the objective digital data may comprise at least both of a geolocation and an associated timestamp, at least one of a RFID number and an IMEI number, at least one of a PIC and a barcode, and at least one of a weight and a quantity.

The method may further comprise receiving, by the one or more computing devices, user-defined data associated with the physical object at or between each node in the physical supply chain, and associating, by the one or more computing devices, the user-defined data with the objective digital data in the digital data chain. For example, the user-defined data may comprise subjective data relating to one or more of primary producer, food safety, nutrition, recipes, provenance, and combinations thereof.

The physical object (or item) may comprise one or more of a raw material, an intermediate material or product, a processed material, an article, a product, a component material or part, a comestible, an animal or livestock, a group of animals or livestock, hopps, grain, forestry products, a metal, a gem, a perishable good, a dangerous or hazardous good, an agricultural or industrial commodity, a luxury good or product, a structure, apparel, a consumer good or product, an electrical circuit or component, a weapon, an explosive, a fertiliser, an agrichemical, an industrial chemical, a pharmaceutical, a drug, an alcohol, a fuel, timber, tobacco, a food, a beverage, a controlled or regulated substance, cannabis, opium, free-range eggs, and transformations, mixtures and combinations thereof.

The physical supply chain may comprise a livestock supply chain, a meat supply chain, a seafood or aquaculture supply chain, a horticultural supply chain, a viticultural supply chain, a feedstock supply chain, a grain supply chain, a hopps supply chain, a tobacco supply chain, a forestry product supply chain, a cannabis supply chain, an opium supply chain, a free-range egg supply chain, and combinations thereof.

The one or more digital devices may comprise one or more of a RFID tag, a write-once RFID tag, a RFID reader, an ultra-high frequency (UHF) tag, an ultra-wideband (UWB) radio transceiver/repeater chip, a sensor supplied or integrated with a label or packaging, an electronic identification device (EID), a barcode scanner, a lab on a chip (LOC), a GPS receiver, a microfluidic device, a drug testing device, a digital weighing scale, a molecular sensor or reader, a health sensor, a digital camera, an optical sensor, a temperature sensor, a humidity sensor, a portable or handheld spectrometer, an acoustic sensor, a mobile computing device, a smartphone, a tablet, a laptop computer, and combinations thereof.

The present invention also provides a computer program product comprising a non-transitory computer usable medium including a computer readable program, wherein the computer readable program when executed on a computer causes the computer to:

a. receive digital data about a physical object located at or between nodes in a physical supply chain, wherein the digital data is collected by and received from one or more digital devices without manual user-defined data input;
b. aggregate the digital data into a digital data chain that is a digital representation of the physical object in the physical supply chain;
c. provide access to the digital data chain to verify one or more attributes of the physical object.

### BRIEF DESCRIPTION OF DRAWINGS

Embodiments of the invention will now be described by way of example only with reference to the accompanying drawings, in which:

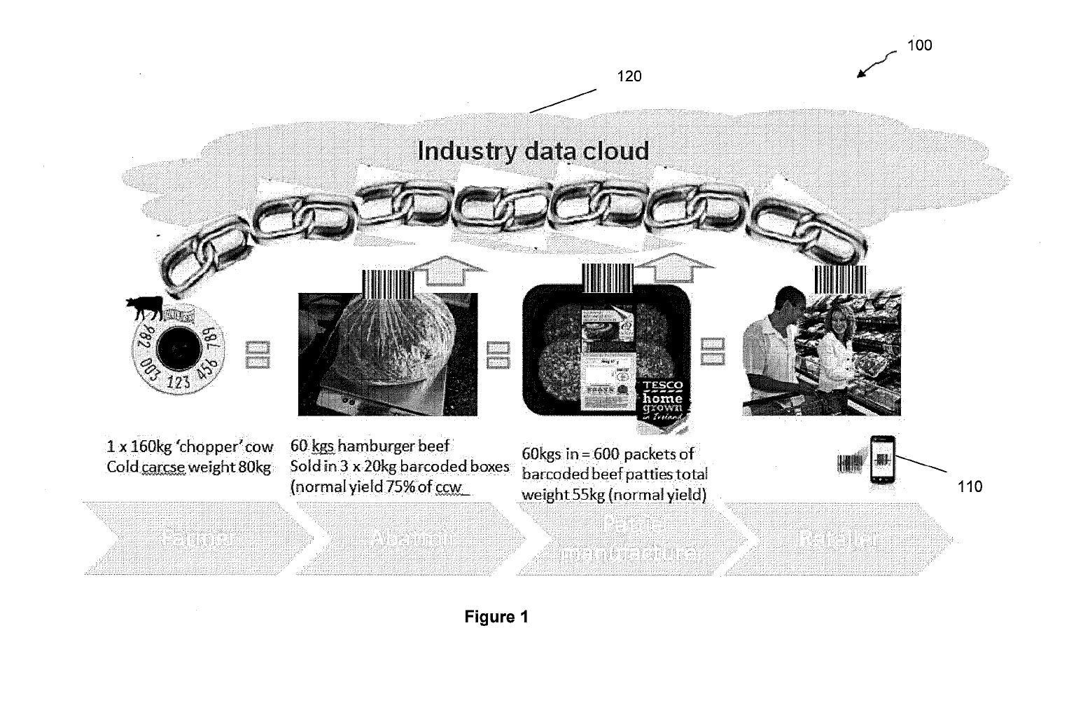

a. FIG. 1 is a block diagram of a system for implementing a method for digital supply chain traceability according to an embodiment of the present invention;

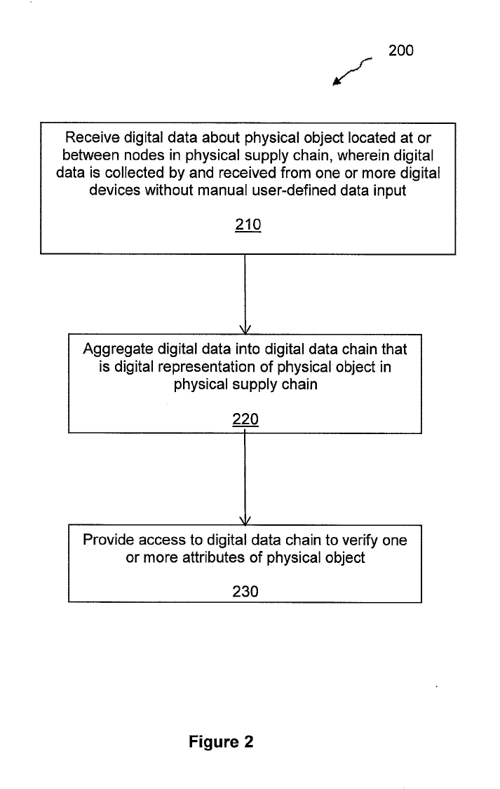

b. FIG. 2 is a flowchart of an example method implemented by the system;

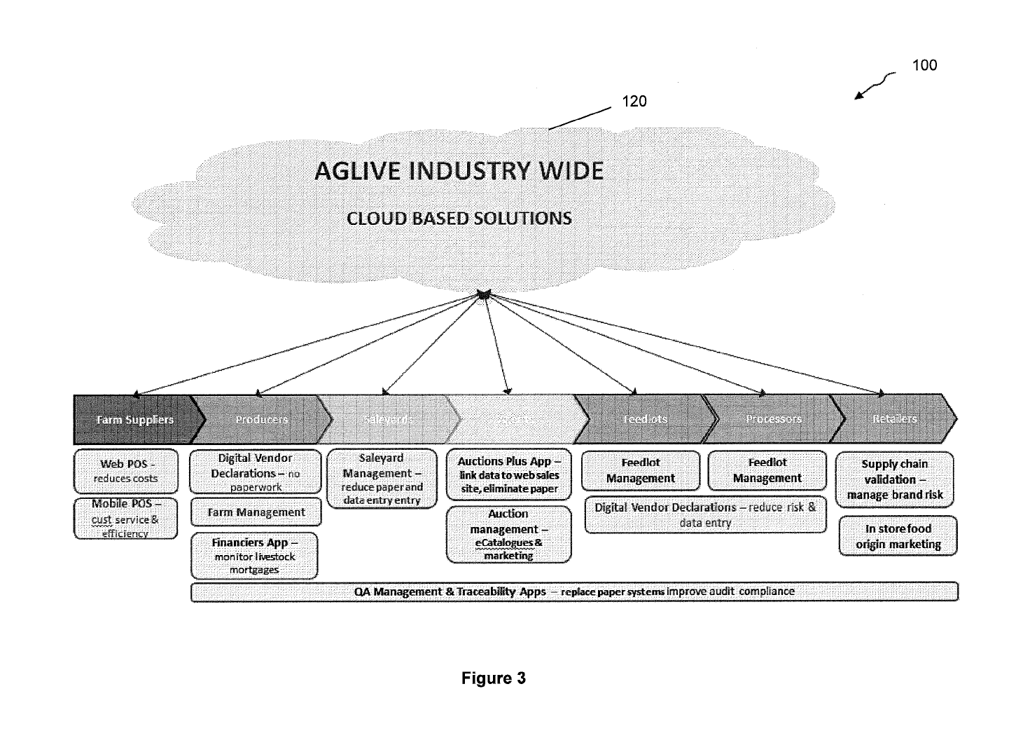

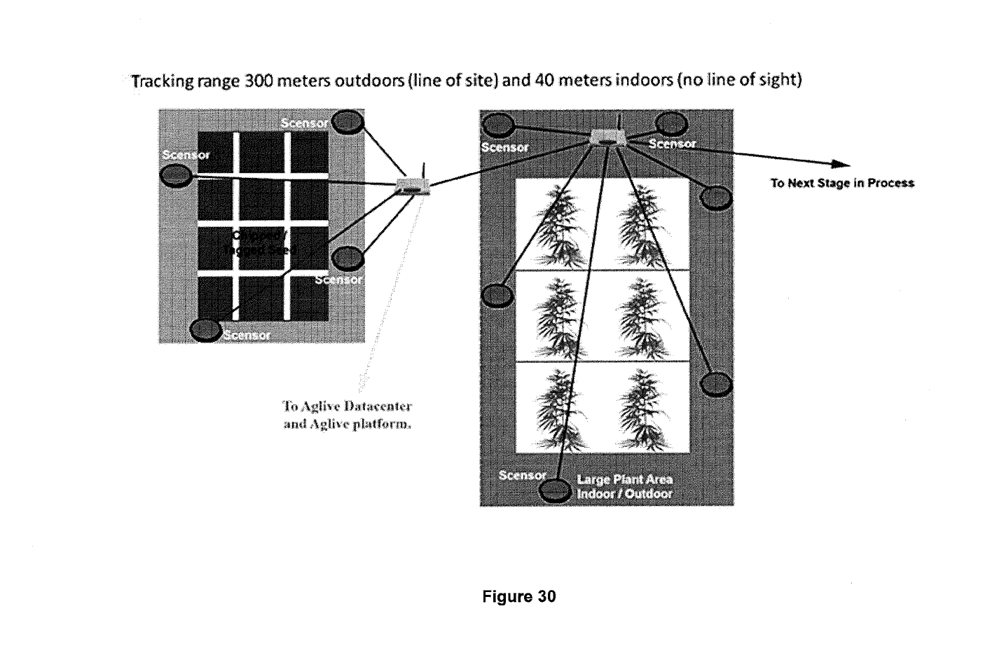

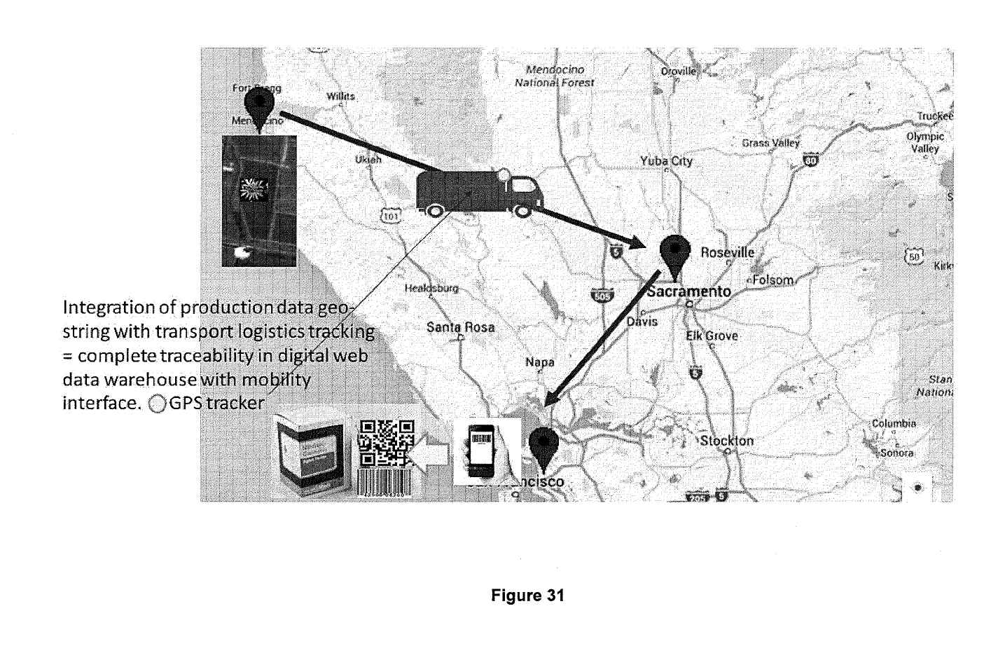

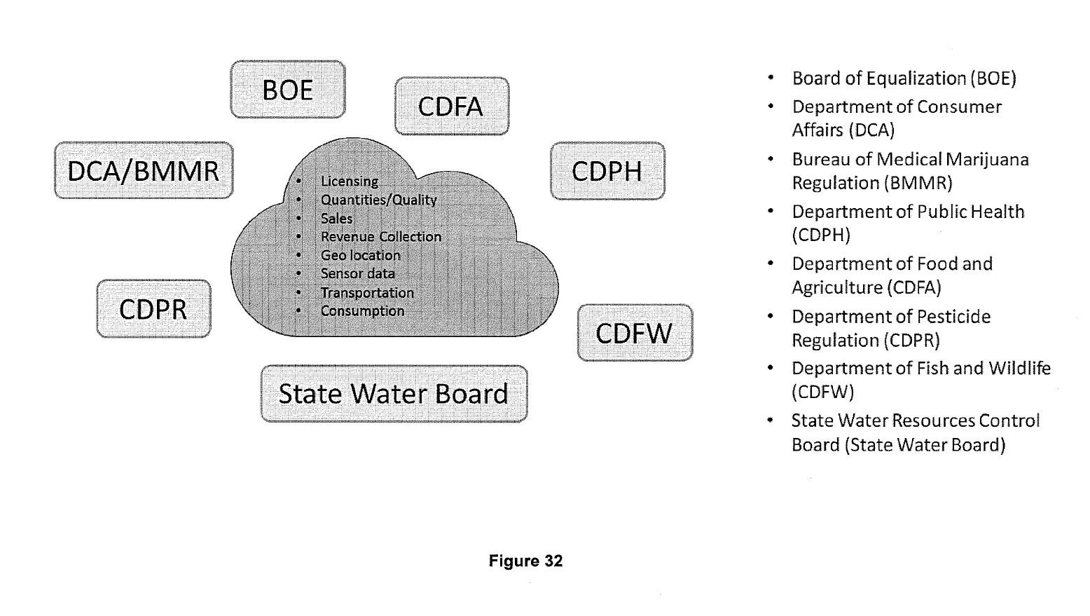

c. FIGS. 3, and 8 to 34, are schematic diagrams of example systems and methods for digital supply chain traceability in different examples of physical supply chains; and

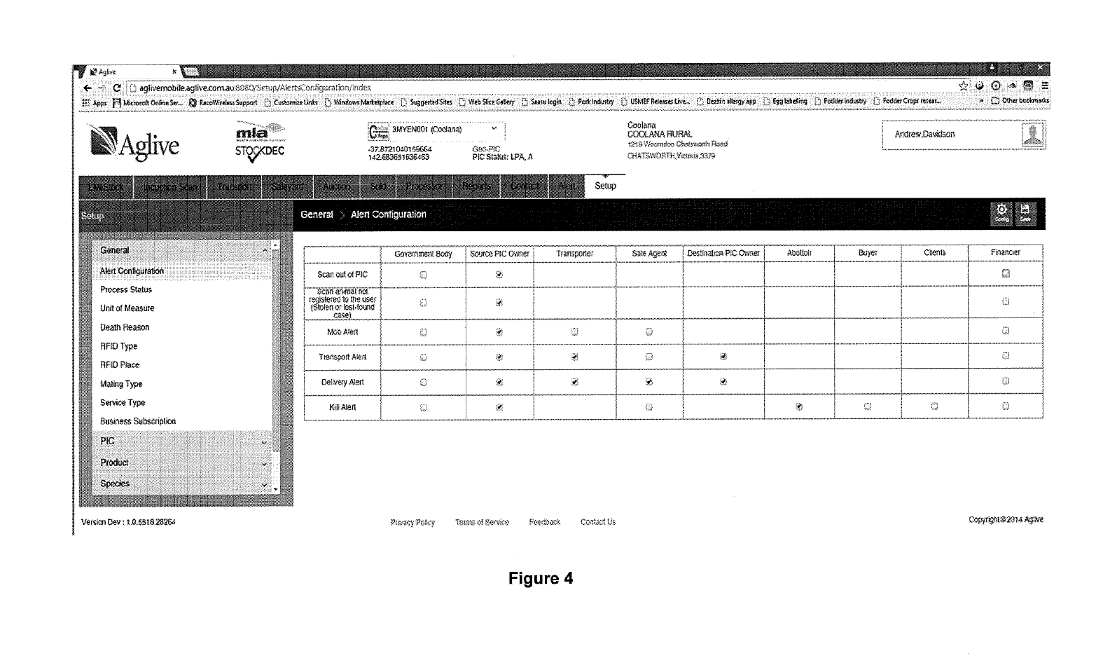

d. FIGS. 4 to 7 are example screenshots of user interfaces presented by the system during implementation of the method.

### DETAILED DESCRIPTION

FIG. 1 is a block diagram of a system 100 for implementing a computer-implemented method 200 for digital supply chain traceability according to an embodiment of the present invention. The system 100 may generally comprise one or more computing devices that implement one or more computer program products (ie, one or more modules of computer program instructions) to perform the method 200. The one or more computing devices of the system 100 may comprise client devices 110 securely connected via a network a cloud data warehouse 120. The client devices 110 may comprise one or more mobile, laptop or desktop computing devices. The cloud data warehouse 120 may comprise an application server (not shown) and an associated server data store (not shown). The application server may be configured to implement a secure web and/or mobile application that provides web and/or mobile services to the client devices 110 for digital supply chain traceability. The web and/or mobile services provides by the application server software may comprise data collection, analytics and management services or digital supply chain traceability. The web and/or mobile application may provide the services as SaaS (software-as-a service) services to subscribers. The subscribers to the SaaS may comprise one or more participants in a physical supply chain, for example, raw material suppliers, farmers, primary producers, manufacturers, processors, exporters, importers, transporters, distributors, wholesalers, retailers, consumers, intermediate or end users, recyclers, inspectors, customs officials, public health officials, quarantine officials, buyers, sellers, agents, advertisers, marketers, auctioneers, financiers, investors, saleyards, marketplaces, mercantile exchanges, industry organisations, government regulators, and combinations thereof. The web and/or mobile application may provide application programming interfaces (APIs) to interface with other web or mobile applications or data stores associated with or used by participants in the physical supply chain.

FIG. 2 is a flow chart of a method 200 for digital supply chain traceability implemented by the system 100. The method 200 begins by receiving digital data at the cloud data store 120 about a physical object (or a plurality of physical objects) located at or between nodes in a physical supply chain. The physical object may be located outdoors or indoors. The digital data may be collected by and received from one or more digital devices without manual user-defined data input. The exclusion of user-defined data input may preserve the integrity of the digital data, and may avoid or reduce inadvertent or deliberate human error, such as misentry, alteration, corruption or falsification of the digital data about the physical object. The digital data about the physical object may be collected automatically or near-automatically by the one or more digital devices in real-time or near real-time in situ at or between each node in the physical supply chain.

The digital data may comprise objective digital data relating to properties, characteristics or attributes that are natural, unique or inherent in or to the physical object. The objective digital data may comprise a digital fingerprint or certificate of location, quantity and quality of the physical object at or between each node in the physical supply chain. Further, the objective digital data may have a standardised data structure, protocol or format that is independent of any standardised data structure, protocol or format associated with the physical object or the physical supply chain. For example, the objective digital data may have a data structure, protocol or format that is standardised at the level of the one or more digital devices. The objective digital data may comprise dynamically determined or acquired geospatial data about date, time and location that may be used to complement, supplement or objectify static, pre-determined or subjective user-entered digital data, such as conventional fixed GS1 barcodes or farm biosecurity codes.

The objective digital data may, for example, comprise at least both of a time and an associated geographic location, and at least one of a unique identifier, an electronic identification number, an International Mobile Equipment Identity (IMEI) number, a radio frequency identification (RFID) number, a Property Identification Code (PIC), a serial number, a barcode, a Quick Response (QR) code, an alpha and/or numeric code, a Global Positioning System (GPS) signal, GPS journey data, a consignment note barcode, a waybill barcode, Geographic Information System (GIS) data, a nutritional composition, an elemental composition, a molecular composition, quantity, weight, volume, mass, density, age, health, a digital image, a blood profile, a drug profile, a drug test result, a genetic profile, a DNA profile, a chemical signature, a biochemical signature, a physical signature, a magnetic signature, an electrical signature, an optical signature, a luminescent signature, an infrared signature, an ultraviolet signature, a temperature, a humidity, a light reflectivity or absorption, an acoustic signature, a colour profile, an altitude, a geo-fence, and combinations thereof.

For example, the objective digital data may comprise at least both of a geolocation and an associated timestamp, at least one of a RFID number and an IMEI number, at least one of a PIC and a barcode, and at least one of a weight and a quantity. Different types of objective digital data may be acquired in situ in real-time simultaneously with one another. The use of location-based digital data to validate origin or provenance of a physical object may be an improvement of having human users affix labels and enter where the physical object was sourced from, for example, by removing the human factor provides increased accuracy and integrity of digital supply chain data.

The physical object may comprise one or more of a raw material, an intermediate material or product, a processed material, an article, a product, a component material or part, a comestible, an animal or livestock, a group of animals or livestock, hopps, grain, forestry products, a metal, a gem, a perishable good, a dangerous or hazardous good, an agricultural or industrial commodity, a luxury good or product, a structure, apparel, a consumer good or product, an electrical circuit or component, a weapon, an explosive, a fertiliser, an agrichemical, an industrial chemical, a pharmaceutical, a drug, an alcohol, a fuel, timber, tobacco, a food, a beverage, a controlled or regulated substance, cannabis, opium, free-range eggs, and transformations, mixtures and combinations thereof.

The physical supply chain may comprise two or more nodes (or steps, stages or points) comprising, for example, a start node, an end node and one or more intermediate nodes. The nodes in the physical supply chain may, for example, comprise two or more of raw material acquisition, analysing, formulation, manufacturing, assembly, disassembly, inspection or testing, vaccination or inoculation, quality control or assurance, import, export, transportation, distribution, retail, use, reuse, maintenance, recycle, repurpose, and disposal.

The physical supply chain may comprise a livestock supply chain, a meat supply chain, a seafood or aquaculture supply chain, a horticultural supply chain, a viticultural supply chain, a feedstock supply chain, a grain supply chain, a hopps supply chain, a tobacco supply chain, a forestry product supply chain, a cannabis supply chain, an opium supply chain, a free-range egg supply chain, and combinations thereof.

The one or more digital devices may be wholly or partially supplied by users and comprise one or more of a RFID tag, a write-once RFID tag, a RFID reader, an ultra-high frequency (UHF) tag, an ultra-wideband (UWB) radio transceiver/repeater chip, a sensor supplied or integrated with a label or packaging, an electronic identification device (EID), a barcode scanner, a lab on a chip (LOC), a GPS receiver, a microfluidic device, a drug testing device, a digital weighing scale, a molecular sensor or reader, a health sensor, a digital camera, an optical sensor, a temperature sensor, a humidity sensor, a portable or handheld spectrometer, an acoustic sensor, a mobile computing device, a smartphone, a tablet, a laptop computer, and combinations thereof.

The method 200 continues by aggregating at the cloud data store 120 the digital data into a digital data chain (or trail) that is a digital representation of the physical object in the physical supply chain (220). The digital data chain may comprise a digital data string that is a unique and dynamically acquired digital representation of one or more attributes of the physical object in the physical supply chain. The one or more attributes of the physical object may comprise one or more of provenance, quality, condition, quantity, weight, composition, location, and combinations thereof. The digital data chain may be formed incrementally at or between each node in the physical supply chain as a cumulative master data string (or master data set). The objective digital data received at or between each node may be a data substring (or data subset) of the overall digital data chain. The digital data substrings may comprise dynamic geospatial digital data about the physical object, and the dynamic geospatial digital data may be used to authenticate, verify, validate, cross check, cross reference, or otherwise objectify static or subjective digital data associated with the physical object, such as barcodes or user-defined digital data.

The method 200 ends by providing access to the digital data chain to the one or more client devices 110 to verify one or more attributes of the physical object. The digital data chain may be used to extend the method 200 to provide a variety of cloud-based supply chain tracking, tracing and management services to users of the client devices 110. As illustrated in FIG. 3, these data services may be implemented via cloud-based software modules, application program interfaces or software applications for a wide range of different users at different nodes in the physical supply chain. For example, the method 200 may further comprise tracking or tracing the physical object along the physical supply chain in upstream and/or downstream directions based on the digital data chain.

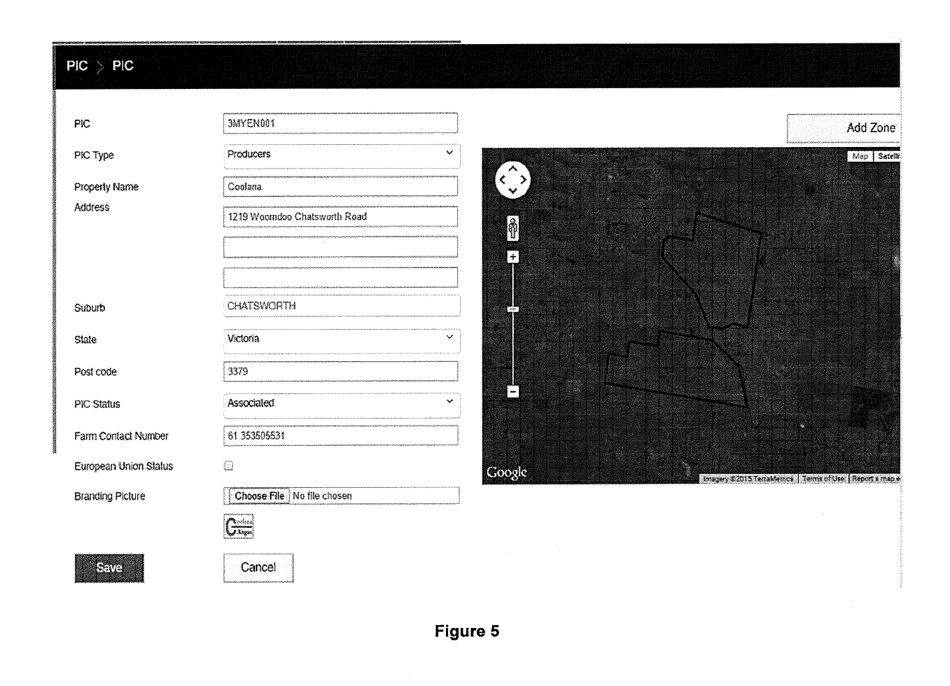

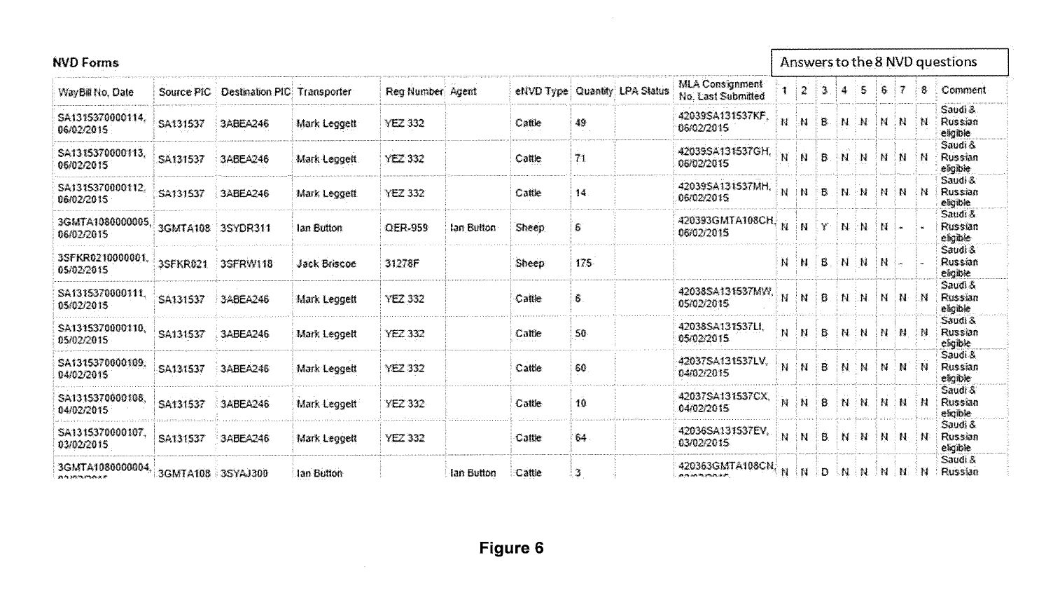

The method 200 may further comprise managing the physical supply chain of the physical object based on the digital data chain. For example, FIGS. 4 to 7 illustrate example screenshots of website interactive user interfaces presented by supply chain management software illustrated in FIG. 3 that enable users to digitally track and trace livestock, such as cattle and sheep, at and between individual nodes in physical meat supply chains. The user interface in FIG. 5 illustrates geo-fences associated with a PIC that may be stored, accessed and manipulated as part of the digital data chain, while the user interface in FIG. 6 illustrates data associated with the Livestock Production Assurance (LPA) National Vendor Declaration and Waybill (NVD/Waybill) that may also be stored, accessed and manipulated as part of the digital data chain.

The digital data chain may further be used by the one or more client devices 110 to plan, manage, audit and monitor the physical supply chain of the physical object. For example, the digital data chain may be used to determine compliance or non-compliance of the physical object with regulations associated with the physical supply chain. For example, the regulations may relate to handling of the physical object, or drug testing or animal welfare when the physical object is an animal.

The digital data chain may further be used to determine a physical break in the physical supply chain of the physical object based on detecting a corresponding digital break in the digital data chain. For example, the absence of objective digital data, or the presence of spurious digital data, in the digital data chain at or between individual nodes in the physical supply chain may be a digital representation of a physical break in the physical chain of origin, title, content, custody and quality of the physical object.

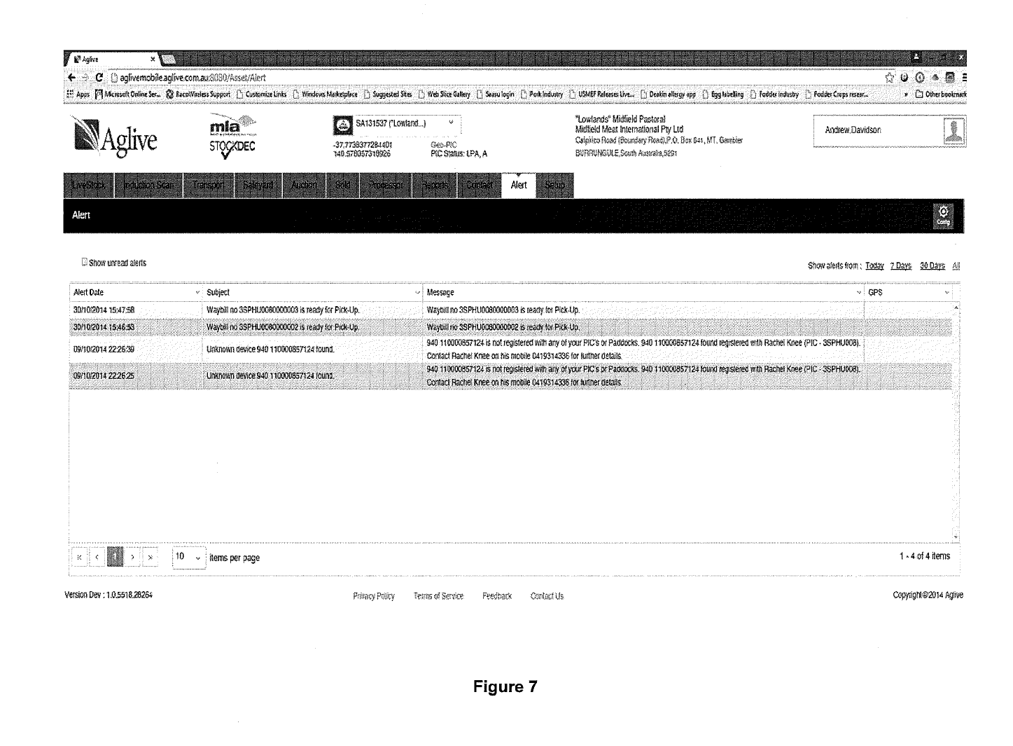

The method 200 may further comprise generating a digital alert upon detecting the digital break in the digital data chain. For example, FIGS. 4 and 7 illustrate example screenshots of website interactive user interfaces that allow users to configure and receive digital alerts corresponding to various actions at or between different nodes in the physical supply chain.

Optionally, the method 200 may further comprise determining an actual, estimated itinerary of the physical object along the physical supply chain, and detecting a departure from the itinerary based on the digital data chain. The method 200 may further comprise detecting one or more of a delay, a diversion, a substitution, a tampering, a chemical change, an environmental change, a temperature change, an alteration, a contamination, an adulteration, a misuse, a mishandling, an undersupply, an oversupply, a theft, an under-production, an overproduction, an overheating, and a counterfeiting of the physical object along the physical supply chain based on the digital data chain.

Optionally, the method 200 may further comprise providing a digital data snapshot of the physical object at or between each node in the physical supply chain based on the digital data chain. FIGS. 4 to 7 illustrate mobile application (or app) user interfaces presented to consumers by the system 100 during implementation of the method 200. For example, the mobile app user interfaces may display digital data snapshots of both objective digital data and subjective user-defined data associated with the physical object to consumers, such as data relating to the primary producer (“meet the farmer”), logistics (“journey to market”), recipes, food safety, and nutrition.

Optionally, the method 200 may further comprise receiving user-defined data associated with the physical object at or between each node in the physical supply chain, and associating, by the one or more computing devices, the user-defined data with the objective digital data in the digital data chain. For example, the user-defined data may comprise subjective data relating to one or more of primary producer, food safety, nutrition, recipes, provenance, and combinations thereof. Furthermore, in animal supply chains, the user-defined or user-initiated data relating to vaccination of animals may be collected and aggregated with objective geospatial digital data about an animal to verify that the animal has been vaccinated. For example, a vaccination vial may be scanned by a barcode or QR reader associated with a smartphone to acquire digital data about the identity, batch and dosage of a vaccine administered to an animal by a farmer. This digital vaccination data may be aggregated in the digital data chain with a geospatial timestamp to capture the date, time and location of administration of the vaccine to an individual animal identified by a geotag. The digital vaccination data may be shared by the farmer with a buyer of the vaccinated animal, such as a feedlot or processor, to verify vaccination and justify a higher selling price for the vaccinated animal compared to an unvaccinated animal.

The invention will now be described in more detail, by way of illustration only, with respect to the following examples. The examples are intended to serve to illustrate this invention, and should not be construed as limiting the generality of the disclosure of the description throughout this specification.

### Example 1: Processed Beef

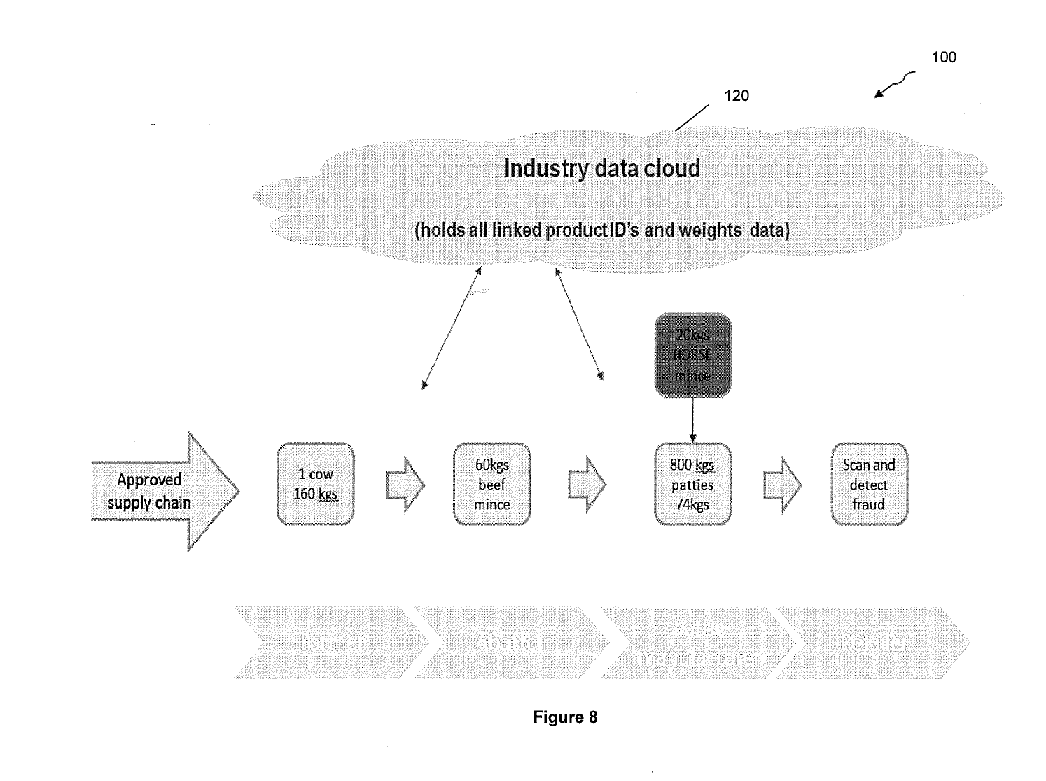

FIGS. 1 and 8 illustrate an example implementation of the system 100 and method 200 for a physical supply chain for processed meat, such as beef patties. The physical supply chain may, comprise a meat supply chain comprising the nodes of farmer, abattoir, patty manufacturer, and retailer. The one or more digital devices at or between each node may respectively comprise a RFID tag reader, barcode scanners, and a smartphone with a barcode or QR code reader app. The physical objects may comprise a geotagged cow, barcoded boxes of hamburger mince, and barcoded packets of beef patties. The users of the system 100 may, for example, comprise a farmer, an abattoir, a pattie manufacturer, a retailer, and a consumer.

The cloud data warehouse 120 may receive objective digital data associated with a “chopper” cow at the farmer's property. The objective digital data received at origin or start node of the physical supply chain may, for example, comprise a geotagged and timestamped RFID number of a RFID tag on the cow, together with a PIC and geo-fence of the farmer's property, and a live or cold carcass weight of the cow.

At the abattoir (or processor), the cloud data warehouse 120 may receive objective digital data associated with barcoded boxes of beef mince processed from the cow. The objective digital data received at processing may, for example, comprise a geotagged and timestamped barcode on the label of each box of beef mince, together with a weight of each box.

The barcoded boxes of beef mince may then be processed further by a patty manufacturer into barcoded packets of beef hamburger patties. The objective digital data received at manufacture may, for example, comprise a geotagged and timestamped barcode on the label of each packet of beef patties, together with a weight of each packet. The same type of objective digital data may then be subsequently received when the packets of beef patties are delivered to a supermarket for retail sale to consumers.

The objective digital data may be acquired in situ at or between (ie, during transport between nodes) each node from smartphones with GPS receivers (not shown), a RFID tag reader, barcode scanners, and smartphones with a barcode or QR code reader app. In addition, the weight data may be acquired in situ from a digital weight scale (not shown) and transmitted to the cloud data warehouse 120 by associated smartphones.

FIG. 8 illustrates that the digital data chain acquired above may be used by the supermarket retailer to detect substitution or addition of horse meat to the beef patties based on the manufactured and packaged weight of the beef patties being outside upstream processing tolerances. The objective digital weight data collected by the cloud data warehouse 120 downstream at the farmer, abattoir and pattie manufacturer may be used upstream by the retailer to detect the substitution or addition of horse meat to the packets of beef patties when they scanned at delivery. The over-weight or over-production of the beef patties may then be traced and tracked back to the pattie manufacturer using the digital data chain as an audit trail of weight.

In this example, all objective digital data collected along the physical supply chain may be sent from wireless mobile digital devices to the cloud data warehouse 120 which stores and process the information for users. Database records comprising the digital data chain may be available almost instantly on the cloud data warehouse 120, making the long, drawn out search through paper records or unlinked data silos obsolete. Paper records were especially problematic during the UK horse meat scandal. It took investigators weeks to trace exactly which farms and slaughterhouses the meat was coming from. Had the physical supply chain been subject to digital record keeping, the horsemeat scandal's investigation time would have been substantially less. In this example, the meat substitution may be detected, traced and tracked in a matter of minutes.

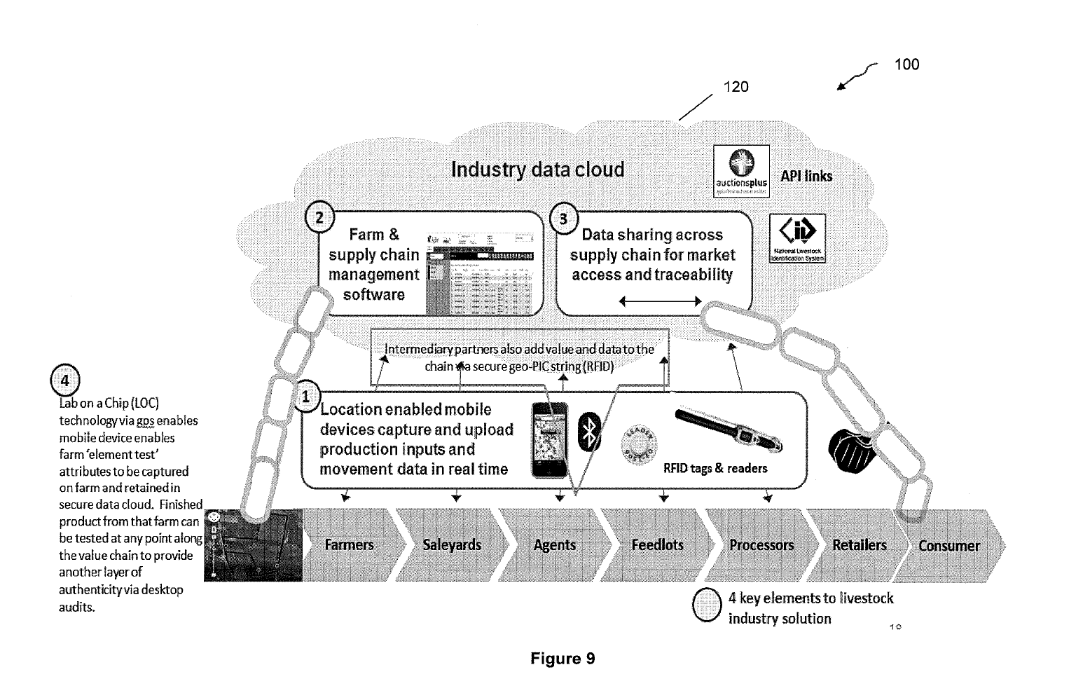

FIG. 9 illustrates a variation of the example illustrated in FIGS. 1 and 8 where the digital data chain may further include digital chemical, elemental or molecular composition data associated with soil and/or feed in the paddock in which the cow was pastured on the farmer's property. The digital chemical, elemental or molecular composition data may be acquired in situ using a LOC (not shown) associated with a smartphone. The digital elemental composition data may be associated with a geo-fence of the paddock acquired in situ from a smartphone with a GPS receiver. The digital elemental composition data and geo-fence data may be analysed by the cloud data warehouse 120 and associated with the other objective digital data acquired at or between each node in the physical supply chain. The digital elemental composition data may, for example, be used to trace and track chemical contamination of the beef patties due to the presence of hazardous chemical residues in the soil and/or feed in the paddock in which the cow was pastured on the farmer's property. Furthermore, the stored digital molecular (and/or elemental) composition data of products may be shared with consumers accessing the cloud data warehouse 120 via smartphones. Consumers may then perform molecular scans of products at points of sale using portable molecular readers associated with smartphones. Consumers may then be able to verify the provenance of the products by comparing the stored digital molecular composition data from the cloud data warehouse 120 with the digital molecular composition data scanned or read from the products directly at the points of sale using the portable molecular readers connected to their smartphones.

It will be appreciated that the digital supply chain tracing and tracking services provided by this example of the invention are not limited to detecting meat substitution or chemical contamination. Instead, the digital data chain provided by this example of the invention may alternatively be used to detect one or more of a delay, a diversion, an alteration, a tampering, a chemical change, an environmental change, a temperature change, an adulteration, a misuse, a mishandling, an undersupply, a theft, an under-production, and an overheating of the physical beef objects as they along the physical supply chain. For example, farmers sending cattle long distances for slaughter on a cents per delivered kilogram basis via GPS tracked livestock transporters may monitor and be assured that cattle have been spelled and watered during transportation within the required timeframes ensuring farmers are not economically disadvantaged by unnecessary weight loss due to lack of water and rest during the transport journey to the abattoir (or processor).

It will be appreciated that embodiments of the present invention are not limited to the particular type of processed meat in this example, but that they may be alternatively implemented for any type of processed meat supply chain.

### Example 2: Export Beef

In this example, the beef patties may be replaced by packaged export beef to be digitally tracked and traced as it moves along a physical export beef supply chain from a farm in Victoria, Australia to a supermarket retailer in Shanghai, China. The digital data chain corresponding to the physical supply chain may be formed in similar fashion to Example 1 above.

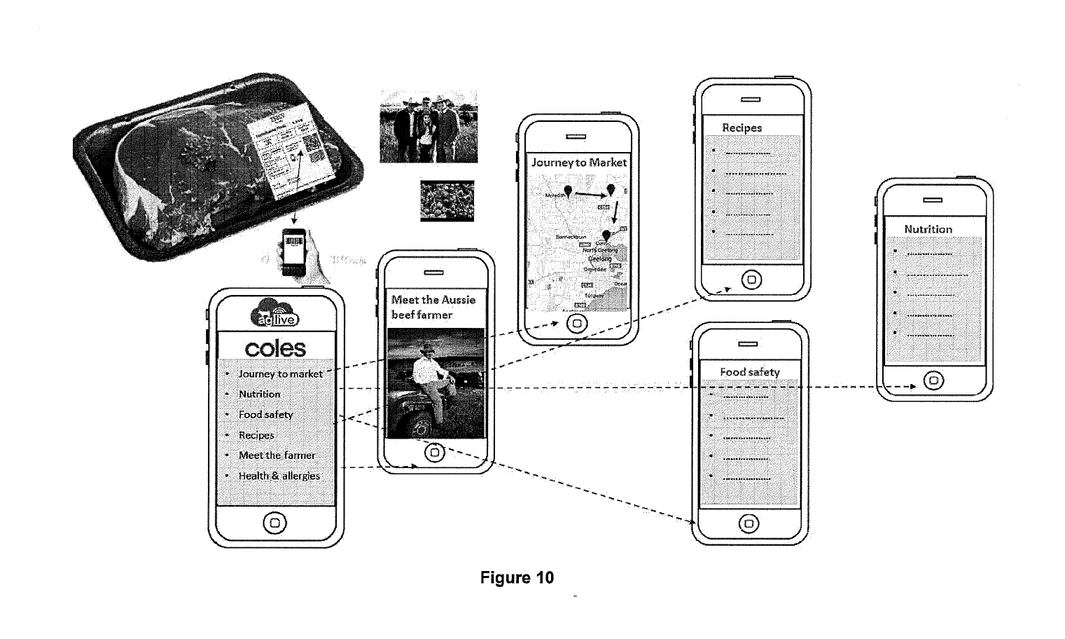

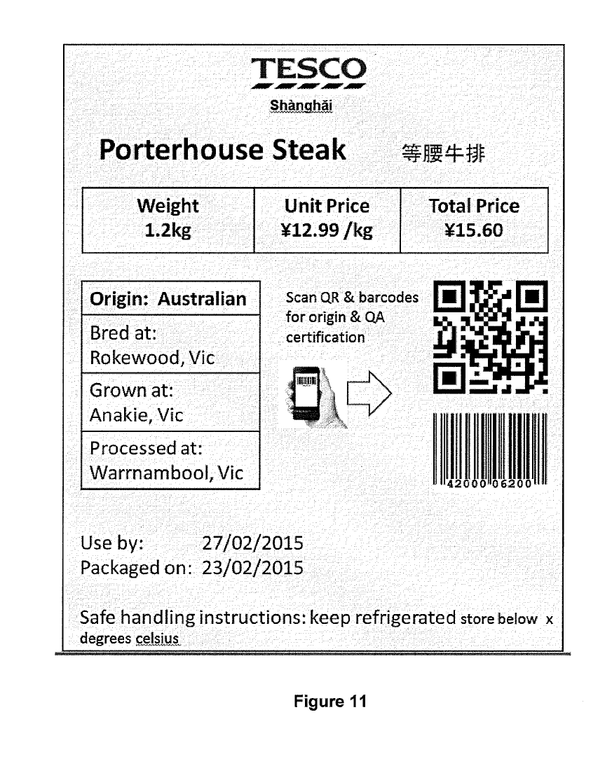

FIG. 10 illustrates example mobile app user interfaces that display digital data snapshots of both objective digital data and subjective user-defined data associated with the Australian packaged export beef to Chinese consumers, such as data relating to the farmer (“meet the farmer”), logistics (“journey to market”), recipes, food safety, and nutrition. Presenting this data to Chinese consumers and allowing them to see the source of the product online may foster consumer involvement and trust. The digital data chain may be retrieved and accessed by the Chinese consumers by scanning an example product label illustrated in FIG. 11.

### Example 3: Bobby Calves

In this example, “bobby” calves may be the physical object to be digitally traced and tracked upstream and/or downstream from the farm to the supermarket retailer. Animal welfare regulations may require any bobby calf collected via a transporter from the farm gate to be slaughtered at an abattoir within 48 hours. Animal welfare is an increasing concern to consumers and processors alike requiring a new generation of visibility and accountability. In this example, the system 100 is configured to provide automated independent electronic validation of pickup location with a geospatial day/date timestamp, and with validation and reporting back to processor slaughter point.

The shared geospatial data cloud 120 may allow bobby calves to be tagged on pickup from farm and then tracked via a transporter installed with GPS tracking to enable digital data about the condition of the bobby calves to be continuously logged and collected while they are in transport between pick-up and drop-off nodes. The objective digital data acquired in situ from the farmer and transporter may then be aggregated in the cloud data platform 120 and shared with the processor to ensure the mandated 48 hour maximum transit time is adhered to or, alternatively, to ensure that the calves are rested, fed and watered if outside this the 48 hour requirement.

It will be appreciated that embodiments of the present invention are not limited to beef cattle or calves, but that they may be alternatively implemented for any type of animal in any type of animal processing supply chain.

### Example 4: Lamb

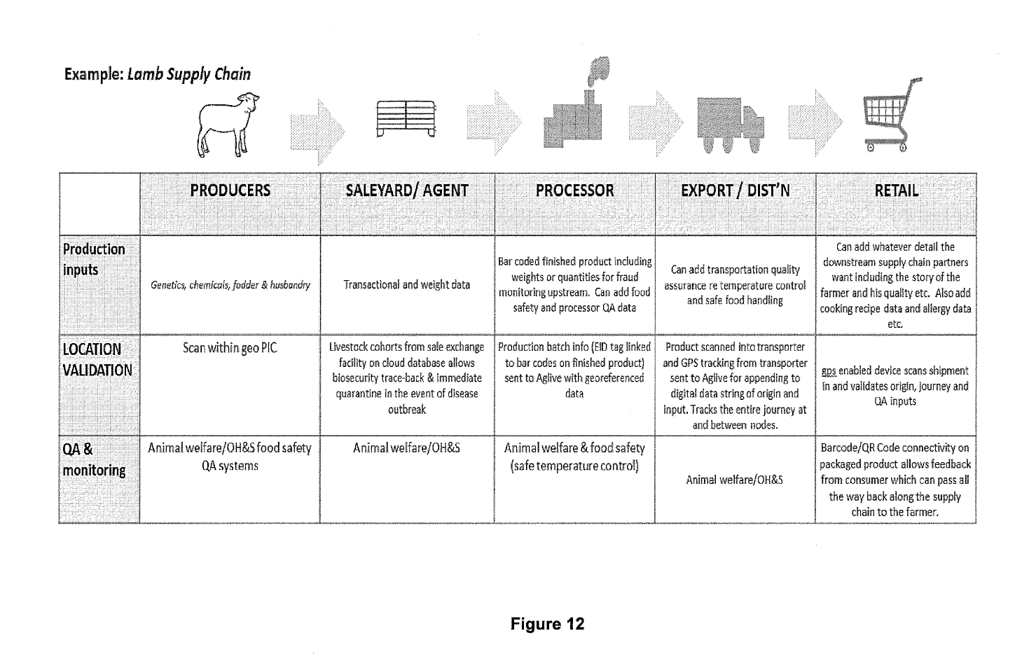

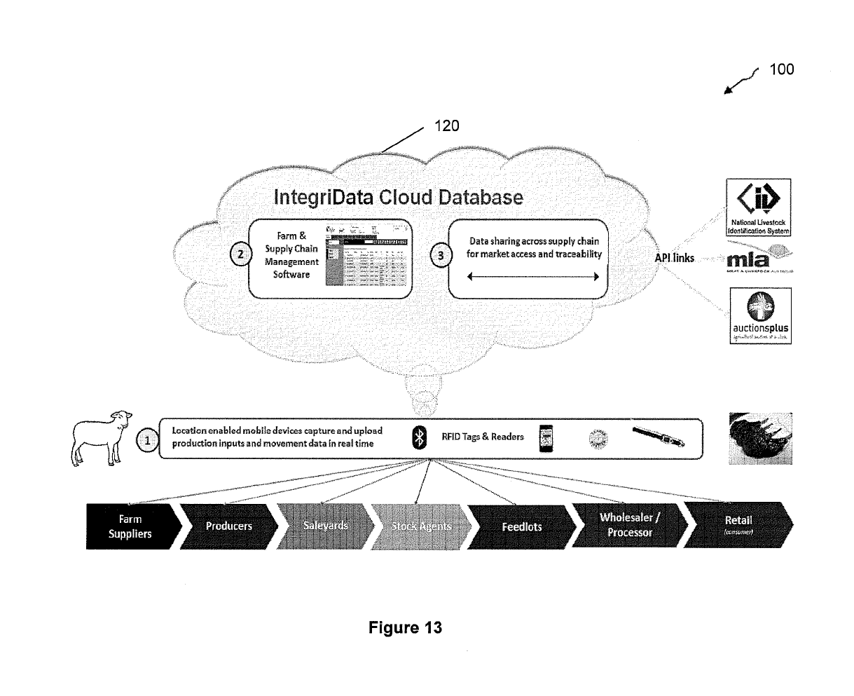

In this example, lambs may be used as the physical object being digitally traced and tracked upstream and downstream through links in the physical lamb supply chain. The data collection, analysis and management services provided by the cloud data warehouse 120 are generally similar to those in the examples above. The table in FIG. 12 and the architecture diagram in FIG. 13 describe and depict example detailed configurations of the system 100 for physical lamb supply chains.

It will be appreciated that embodiments of the present invention are not limited to physical food supply chains involving livestock, animals or processed meat products, but that they may be alternatively implemented for any type of food supply chains for any type of horticultural or aquacultural materials.

### Example 5: Sheep Mobs

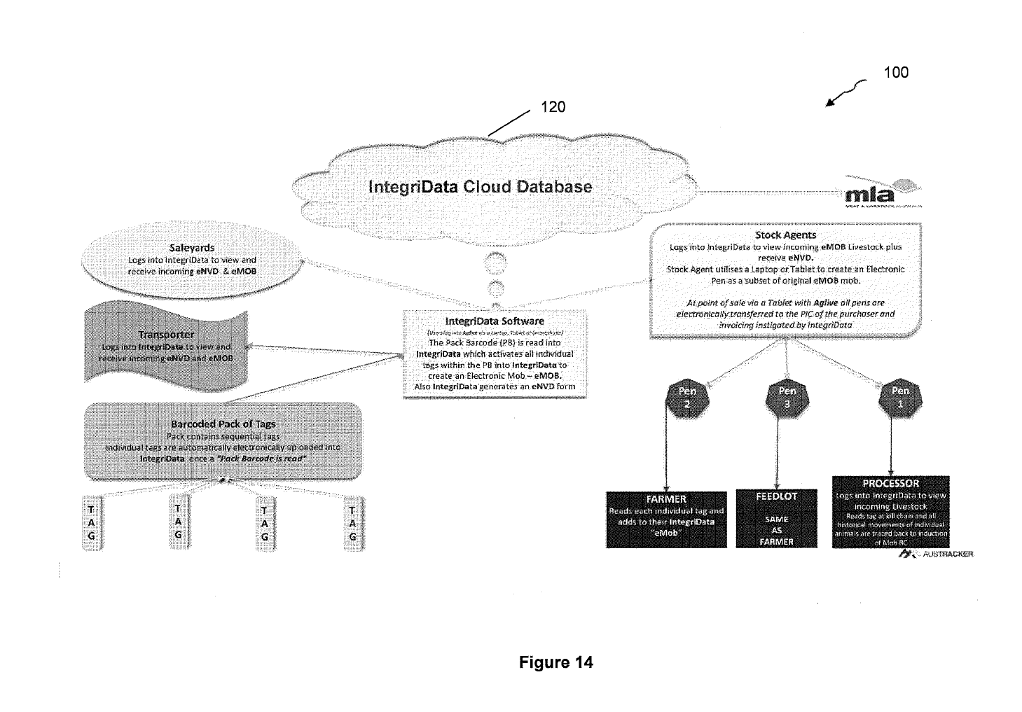

FIG. 14 illustrates an example implementation of the system 100 and method 200 for tracking movements of groups of livestock, such as mobs of sheep. In sheep supply chains it is currently not mandatory for farmers to affix RFID tags to sheep entering the food supply chain, as they are only required to affix a plastic tag with their property number (PIC) code. In some countries, such as Australia, there is a major push from regulators and processors to require farmers to affix mandatory RFID tags for improved traceability. Sheep get foot and mouth disease (FMD) and do not die, however they infect the cattle and they all die (ie, sheep spread the FMD outbreak in the UK, and now cattle are also required to be EID tagged in the UK). If Australian farmers do not RF tag sheep, then they may lose access to our red-meat export markets. Farmers are resistant to RF tagging of sheep due to cost. RF tags cost $3.50, and while this cost may be acceptable for a $1000 cow, it is not economically viable for a $100 per head of animal, for example, lamb, hogget, mutton, ewe, whether, ram, etc. Another practical problem is how to scan tens of thousands of sheep with slow reading and short range low frequency tags in a fast moving saleyards environment.

In this example, the system 100 and method 200 provide a solution as a single industry cloud database. Sheep may be fitted with existing plastic tags with bar codes (or low cost UHF tags), and consigned to market from farm gate or feedlot by transporters with consignment note/waybill data and tracked as a mob using a GPS-enabled digital device, such as a smartphone. The saleyards do not need to scan the animals as they all end up with another farmer, feed lot or processor for slaughter. The scanning of the animals at these three end-destination PICs may be used to back fill the database relieving the inventory of the supplier farmer and populating the inventory of the stock agents and buyers with individual EID tagged animals in individual pens or sale lots.

The tags may be RFID 134.2, Gen2 UHF, Barcode, QR Codes or standard Flock tags. For example, NLIS Flock tags are already provided with regulatory information printed on one side. A barcode printed on the other side at a minimal cost to growers that may be estimated to be around 5 to 7 cents per tag. Using the additional barcode on a flock tag may deliver the capability to track individual animals from paddock to plate and beyond using the system 100 and method 200. Packs of tags (“parent”) may be provided in minimum quantities of twenty to one hundred, and each pack may be barcoded. Each pack may contain tags in sequential order, and will be “children” of the barcoded pack of tags. The packs must be read on the GeoPIC property of use. All tags in the pack and individual tags within the pack will be allocated to the PIC number of the property via GPS validation of GeoPIC location with a time and date stamp.

Within a mobile application provided by the system 100, an electronic mob will be generated which reflects the mob (packs of tags) on the PIC property. This digital mob data may be is electronically transferred to a selected PIC via the mobile application. The acquiring PIC (transporter, saleyards, and stock agents) may electronically accept the physical mob. The stock agent may then split the mob into smaller mobs via the allocation of sub-sets of barcode within digital data chain.

When the sub-set mob is sold, they may then be electronically transferred using software provided by the cloud data warehouse 120 to the selected PIC (ie, farmer, lot feeder or processor). The acquiring PIC owner may then read each individual tag and then allocate to a mob within the cloud data warehouse 120. In the event an abattoir purchases the livestock, the reading of tags may take place on the kill chain via a “live chain” reader. All these actions may be completed using software provided by the cloud data warehouse 120 to enable individual animals to be digitally tracked and traced back to the starting node at their property of origin. The system 100 may also provide the ability to back fill EID data on sold animals in the specifications. Another feature of the location-based digital data chain stored in the cloud data warehouse 120 may be the ability to link in with industry/government GIS data in relation to their database of properties which have been tested and are active for chemical residues in the soil. This allows the system 100 to automatically detect and prevent or alert the supply chain where an animal is being consigned which has been resident on an ERP (Extended Residue Program) PIC.

### Example 6: Wine

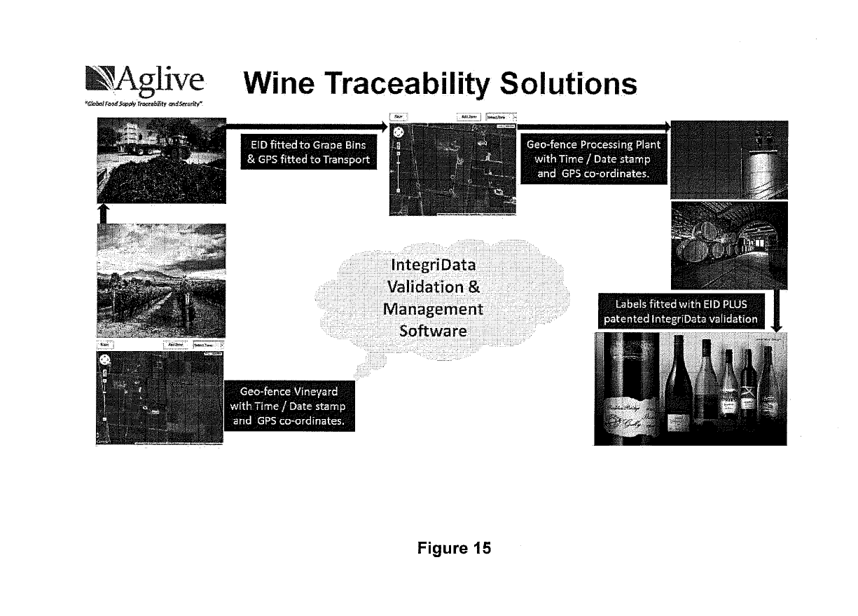

FIG. 15 illustrates an example embodiment of the system 100 and method 200 suitable for digitally tracing and tracking viticultural materials and wine products as they move along the physical supply chain. Grape growers may be are able to scan, geotag and timestamp rows of grape vines in situ using digital devices, such as EIDs, to identify from which geo-fenced lots on a vineyard the grapes were picked. Once the grapes have been picked and are ready to be shipped from the vineyard for processing, they are scanned, geotagged and timestamped again in bulk transport bins fitted with EIDs and/or having barcodes, allowing wine retailers and consumers to know exactly which lot on which vineyard the grapes used to make the bottled wine come from. The same objective digital data collection and analysis may be performed when the grapes enter bulk vats as bulk wine and barrels as barrel-aged wine until the bottled wine reaches the retailer and consumer.

The bulk vats and barrels may be fitted with EIDs and/or have barcodes. Further, the digital data chain may also comprise digitally-acquired weights and volumes of the grapes, bulk wine and barrel-aged wine to prevent or minimise diversion or substitution during processing. To prevent or minimise counterfeiting of the bottled wine, labels applied to the wine bottles at packaging may have a write-once RFID tag which is used to generate a unique geotagged and timestamped RFID number for individual wine bottles.

### Example 7: Frozen Mixed Berries

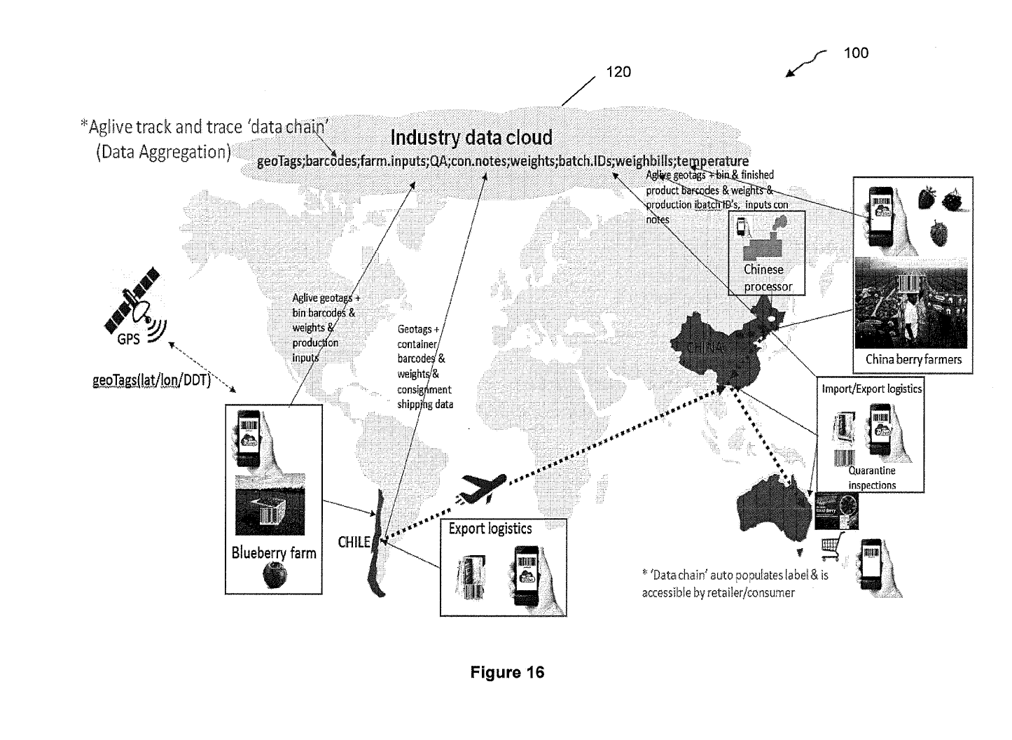

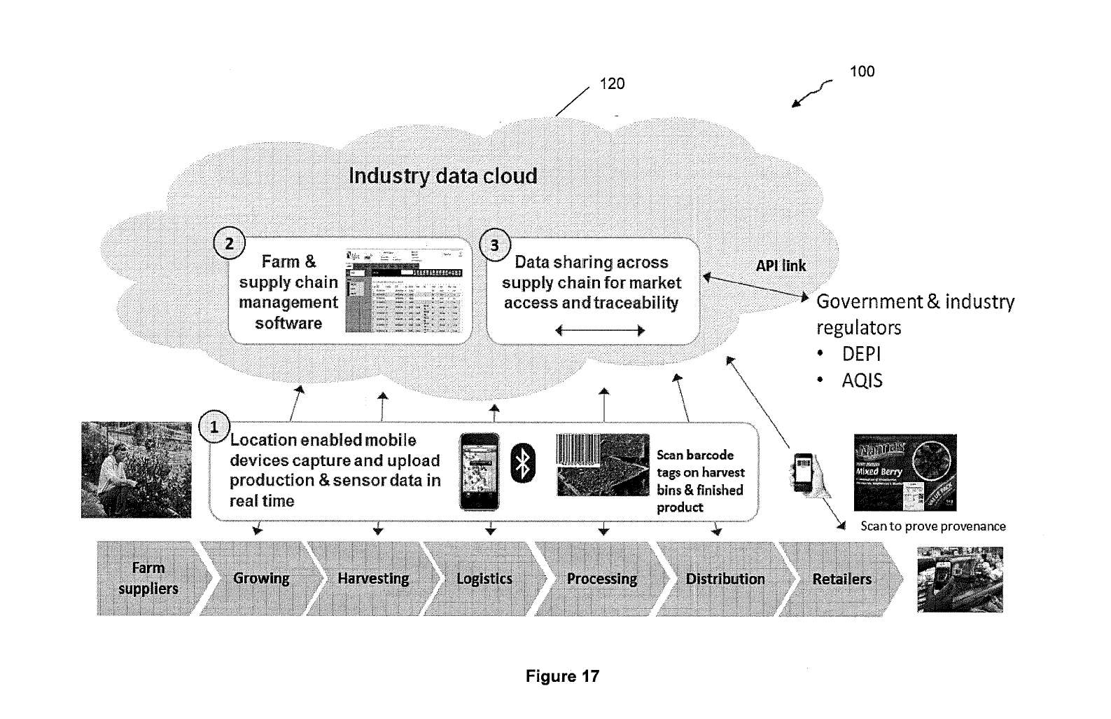

This example is similar to the export beef example above, except that the physical supply chain involves mixed frozen berries. Referring to FIGS. 16 and 17, different types of berries may be respectively sourced from berry farms in Chile and China. The berries may be exported to from Chile to a processor in China to mix with berries to form packets of frozen mixed berries. The packaged frozen mixed berries may then be exported to Australia and sold in supermarkets.

In this example, objective digital data relating to each of the component berries and the berry mix may be acquired in situ at or between each node in the global physical supply chain. The cloud data warehouse 120 may then provide the resulting digital data chain to public health officials and supermarkets in Australia to digitally trace, track and recall the mixed berries in the event that they are associated with a public health crisis, such as a hepatitis outbreak.

The digital data chain may enable the berries to be tracked from their point of origin to its retail outlet. The cloud-based track-and-trace system may be used not only to track the location of the individual and mixed berries as they move through the physical supply chain from the grower to processor to retailer in the three different countries, but also to provide vital information about environmental fluctuations in temperature, humidity, and light as the berries are transported between nodes. This may enable real-time tracking on the product level, and parameters for humidity and temperature may be checked for food safety while the materials are en route. The system 100 may allow for boundary alerts that prevent the materials from crossing certain geographical boundaries for import/export if the digital data chain indicates that the safety of the berries has been compromised at any particular link in the physical supply chain. One of the most important benefits of digitally tracing food products in this example may be the ability to quickly and accurately identify where in the physical supply chain a product became contaminated in the event of a recall.

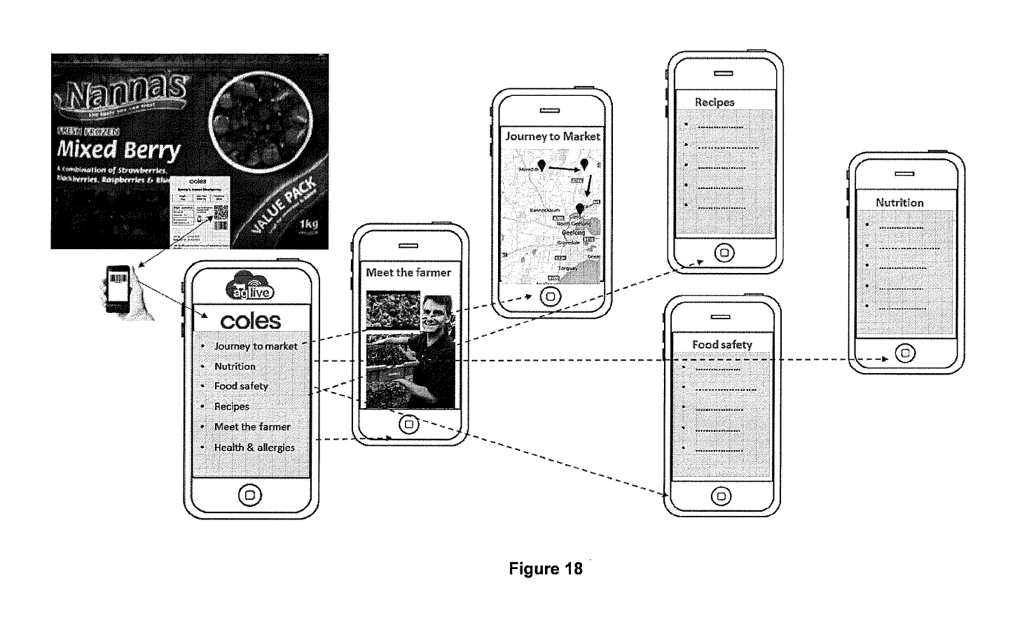

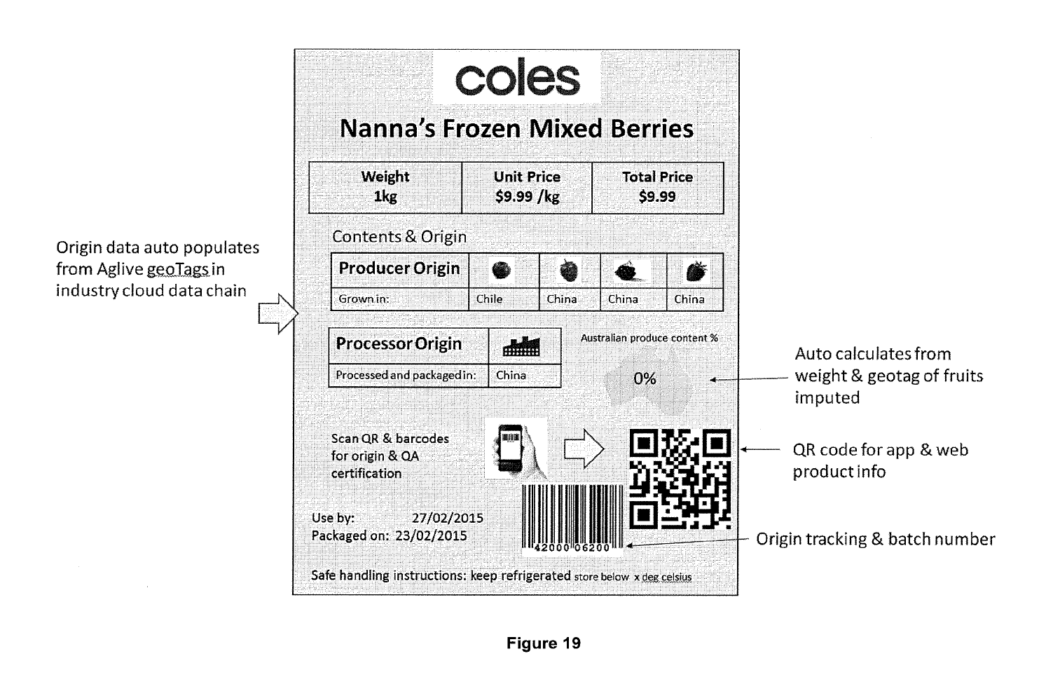

FIG. 18 illustrates example mobile app user interfaces that display digital data snapshots of both objective digital data and subjective user-defined data associated with the packets of frozen mixed berries to Australian consumers, such as data relating to the farmer (“meet the farmer”), logistics (“journey to market”), recipes, food safety, and nutrition. Presenting this data to Australian consumers and allowing them to see the source of the product online may foster consumer involvement and trust. The digital data chain may be retrieved and accessed by the Australian retailers and consumers by scanning an example product label illustrated in FIG. 19.

### Example 8: Seafood

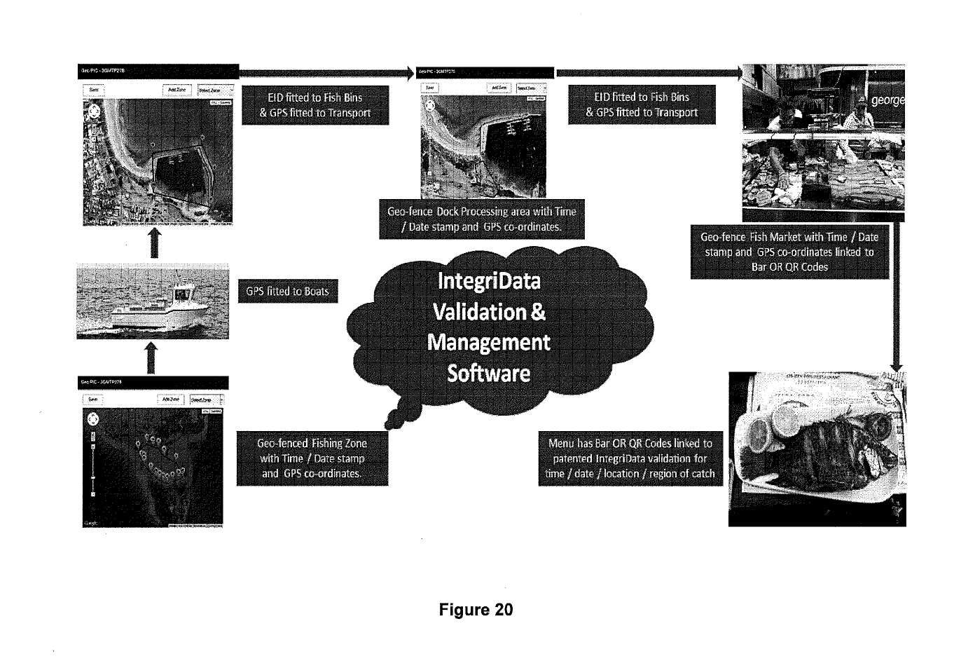

FIG. 20 illustrates an example implementation of the system 100 and method 200 for seafood supply chains. In this example, licensed and authorised fishing zones and licensed areas may all be marked out on GIS maps allowing the data to be easily overlayed on the cloud data warehouse system via a Keyhole Markup Language (KML) data file. Fishing boats may have dual GSM/satellite mobile device on board and be allocated a PIC with authority to operate in certain geo-fenced fishing zones. Catch may be digitally weighed on board into crates fitted with EIDs and/or having barcodes. The catch may be landed at geo-fenced and timestamped dock processing areas and processed into fish bins fitted with EIDs and/or having barcodes.

The fish bins may then be transported to geo-fenced and timestamped fish markets or retail seafood outlets. Fishing boats may have GPS tracking interfaced into the cloud data warehouse 120 ensuring that fish are only caught in licensed areas. The digital data chain may provide this objective digital data to wholesalers and retailers allowing customers to buy only genuine local-caught fish. For example, the geo-fenced and timestamped digital data acquired at each link in the fish supply chain to validate the time, date, location and region of the seafood catch may be accessed by consumers via barcodes or QR codes at purchase from the fish market, or from a menu at consumption in a seafood restaurant. Objective digital data acquired from digital LOC devices may allow another layer of desktop audit and testing at retail level.

### Example 9: Harness Racing Horses

To be eligible to race, harness racing horses may be required to submit to a drug test at a specified location within a specified time in advance of the race. The system 100 may be configured to collect, analyse and share geotagged and timestamped drug test results acquired from the horse in situ by a digital LOC or drug testing device at a specified testing location. The digital data chain may comprise a blood profile or drug test result that is checked by harness racing officials before a race. It will appreciated that this embodiments of the invention are not limited to harness racing horses, but that they may be alternatively implemented for any type of racing animal, such as flat and jump racing horses, and racing greyhounds.

### Example 10: Free-Range Eggs

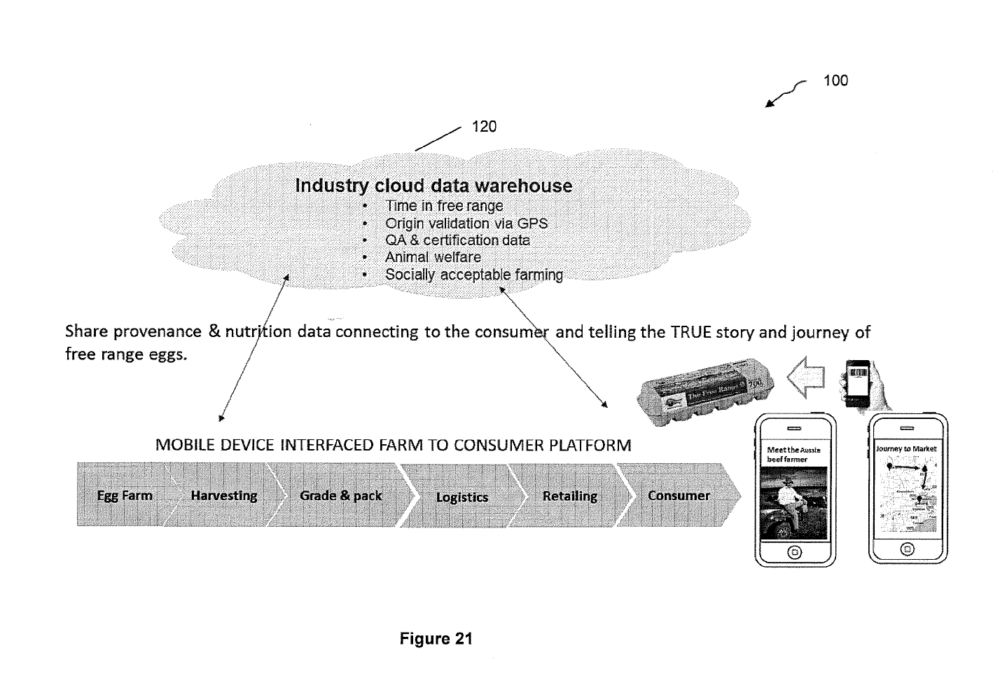

Consumers are willing to pay a premium for free-range eggs. For eggs to be labelled free range, current regulations require there should be a maximum of 10,000 hens per hectare. But many commonly available “free range” brands do not adhere to this, with some brands keeping as many more hens per hectare. FIG. 21 illustrates an example implementation of the system 100 and method 200 to provide on demand real-time evidence to consumers to support brand claims that their eggs are free-range, eggs.

The cloud data warehouse 120 may receive digital data from UWB real-time location service chipsets fitted to mobile chicken houses in a free range paddock to track collection and packing of eggs at a packing facility. UWB tracking chips may also be used as EID tags for egg crates, trays and cartons. Digital data may also be received from UHF RFID leg bands to track chickens entering and exiting chicken houses in free range areas. Walk-over UHF scanners may be provided at entry and exit points in the mobile hen houses to monitor and track hen movements. Digital data about hen exit and entry may be used to calculate times hens are outside in free range, and inside hen houses in egg production. Digital data may also be received from these internal and external environment sensors to provide digital data about welfare monitoring of temperature and free range time, water and feed monitoring, and walk-over “in field” weighing of hens. Wireless communications fixed to GPS and UWB anchors and sensor poles in free range areas and receivers on chicken houses may be powered by solar panels and battery packs fitted to chicken houses. A Wide Area Network (WAN) controller unit computer card with a SIM card may be provided for GSM wireless connectivity.

The digital data collected in situ by the above digital devices may be aggregated by the cloud data warehouse 120 into a digital data chain that is a digital representation of the free-range egg supply chain. The digital data chain may then be accessed by producers and shared with consumers to track free-range hens in real-time. For example, GPS location geo-strings with data time and latitude/longitude stamping may be provided to verify egg origin to consumers. The digital data chain may be further accessed and shared to provide location monitoring of mobile hen houses in free range areas, hen welfare monitoring (eg, temperature, humidity and weather), geo-fencing of free range areas, tracking egg production and quality assurance both indoors and outdoors. Further, digital snapshots from the digital data chain may be integrated with egg packaging labelling to provide provenance data to consumers and verify claims that the eggs are free range. Sharing provenance and nutrition data from the digital data chain may connect consumers to the supply chain and tell a factual story about the journey of free ranges eggs from farm to supermarket.

### Example 11: Milk Production

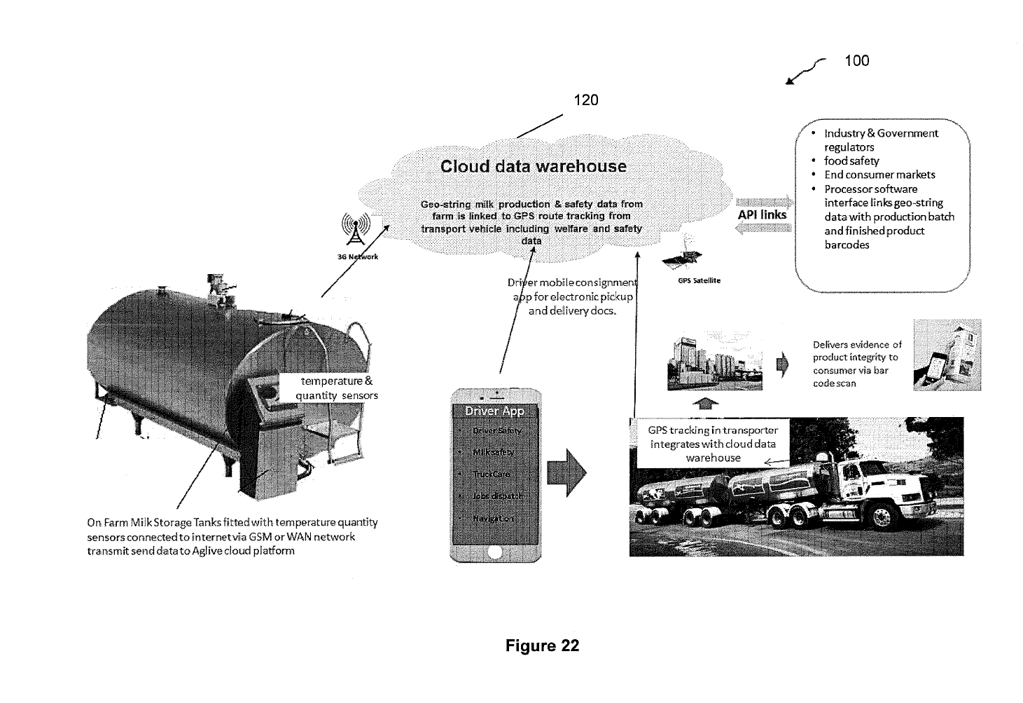

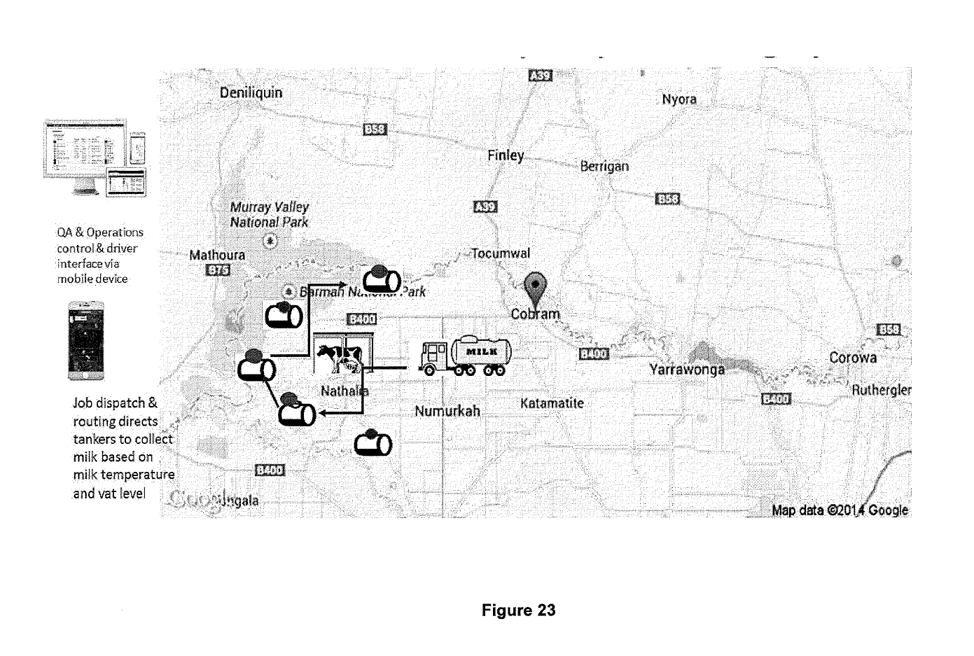

FIGS. 22 and 23 illustrate an example implementation of the system 100 and method 200 to provide digital monitoring and traceability of milk production and transport for evidence-based traceability and product integrity. Geo-string milk production and safety data from dairy farms may be aggregated with GPS route tracking and welfare and safety data from transport vehicles into a digital data chain that digitally represents the physical milk supply chain. The digital evidence of product integrity may be accessed by consumers at points of sale by scanning product bar codes with smartphones.

### Example 12: Biosecurity Monitoring and Control

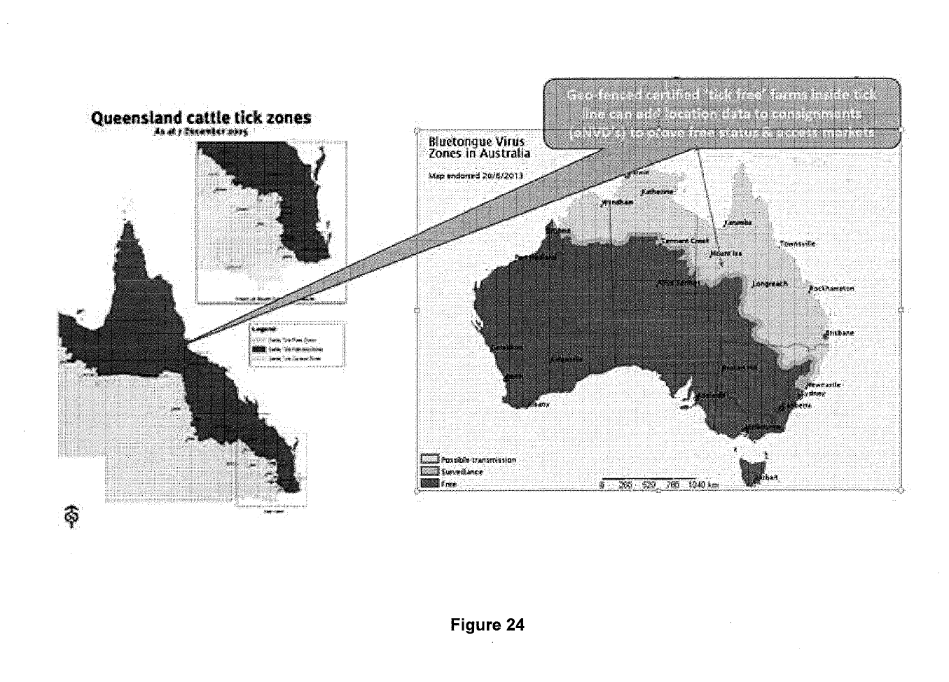

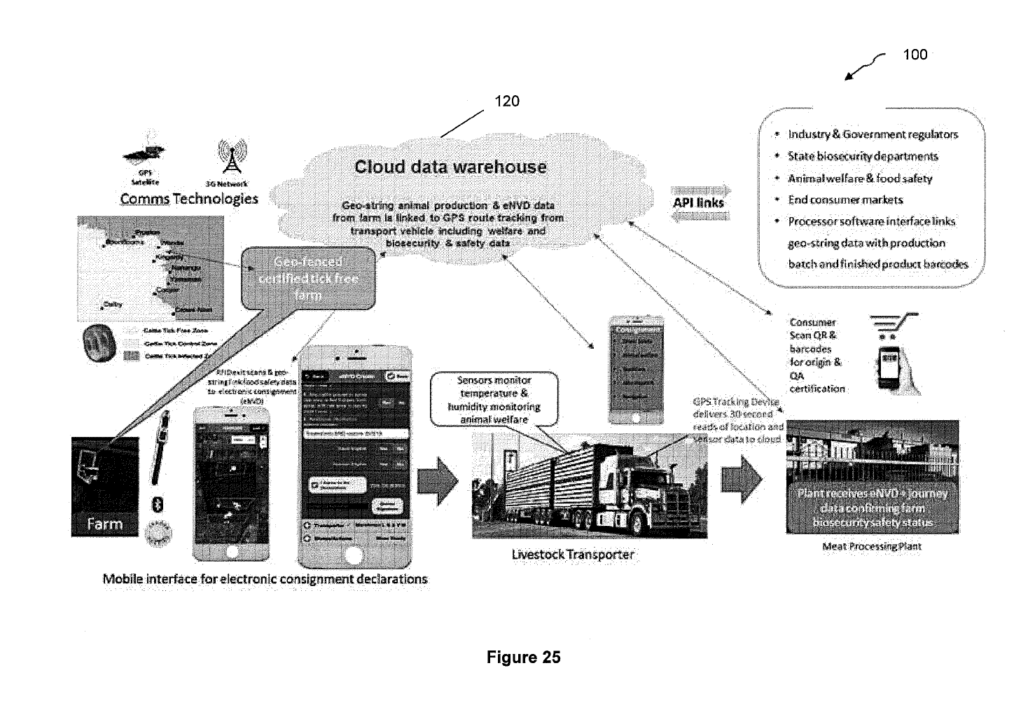

FIGS. 24 and 25 illustrate an example implementation of the system 100 and method 200 to provide digital monitoring and control of biosecurity hazard zones, such as cattle tick zones or Bluetongue virus zones. Geo-string animal production data and eNVD data from farms may be aggregated with GPS route tracking and welfare and biosecurity data from transport vehicles into a digital data chain that digitally represents the physical animal supply chain. The digital evidence of product integrity may be accessed by processors and government regulators to confirm the biosecurity safety status of farms, animals and transport vehicles. As discussed above, the digital data chain advantageously comprises dynamic geospatial and temporal digital data about dates, times and locations of animals or plants as they move between and among nodes in physical supply chains. The dynamic geospatial and temporal digital data in the digital data chain provides biosecurity monitoring and control at greater levels of resolution and accuracy compared to conventional static biosecurity codes that are fixedly allocated to individual nodes, such as farms. As also mentioned above, the dynamic geospatial and temporal digital data may be used to supplement and objectify conventional static biosecurity codes

### Example 13: Grain Finished Beef

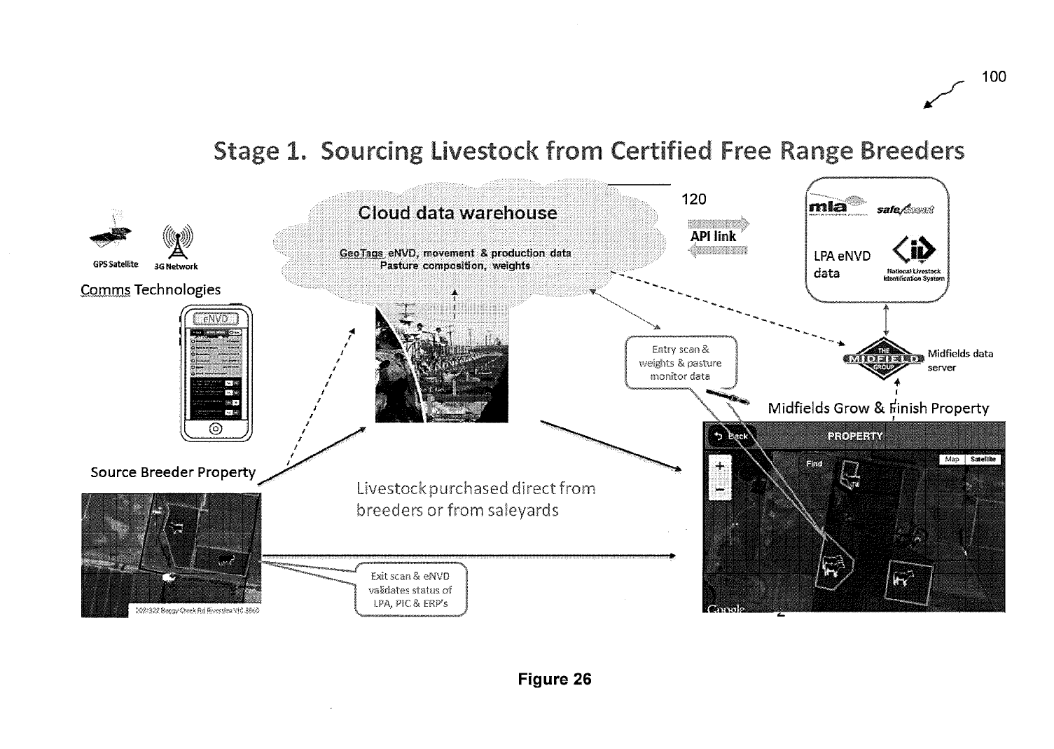

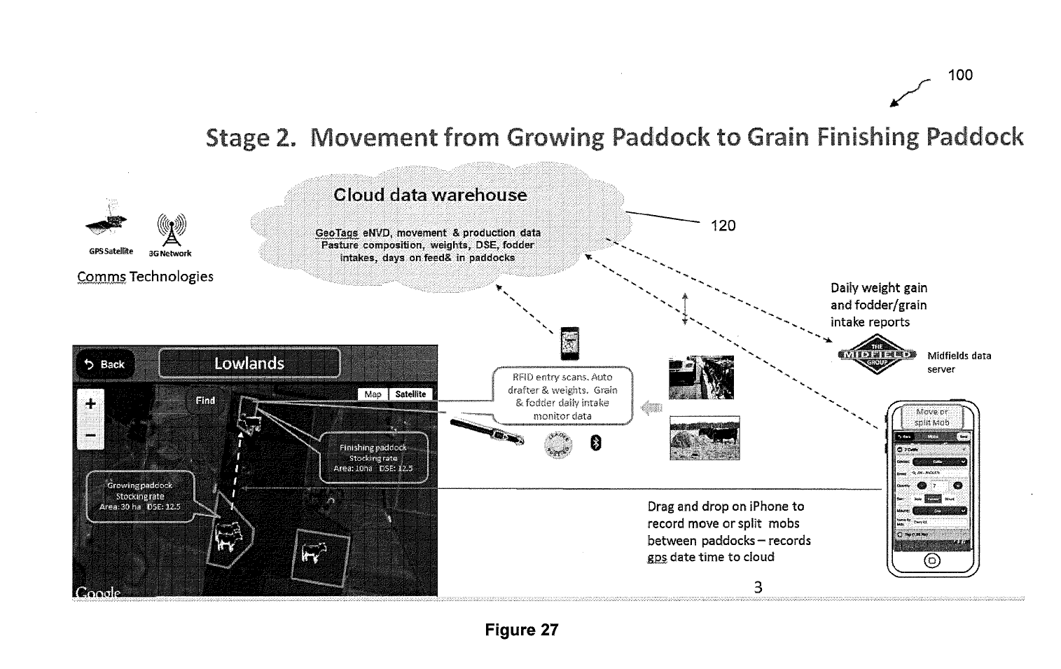

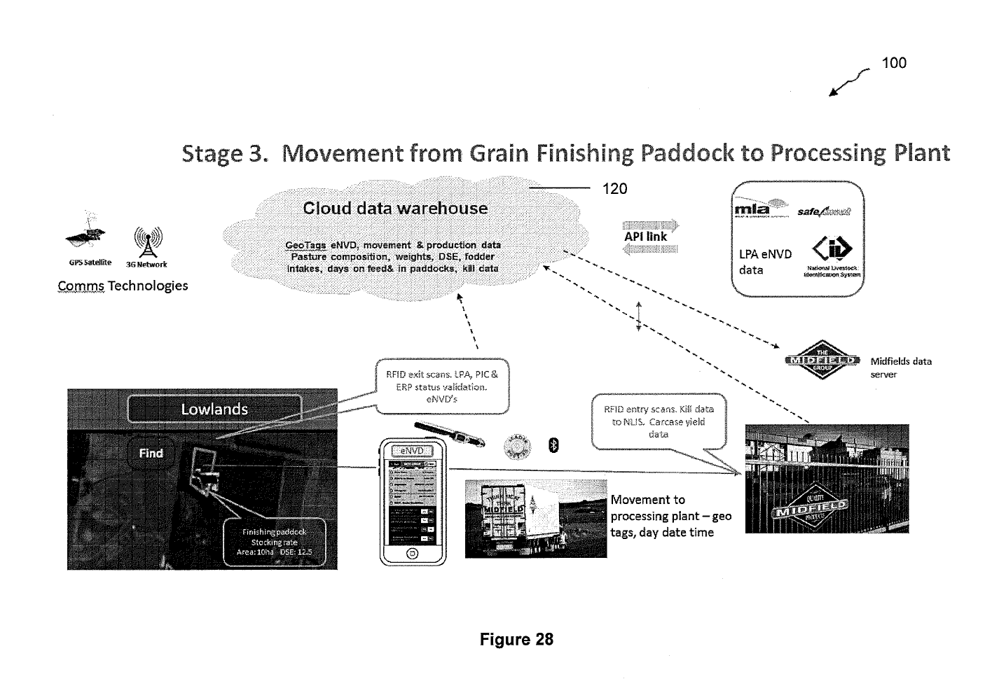

Similar to free-range eggs in Example 10 above, consumers are willing to pay a premium for certified free range grain finished beef. FIGS. 26 to 28 illustrate an example implementation of the system 100 and method 200 to provide digital traceability at and between each stage of the physical supply chain. FIG. 26 illustrates collection of digital data during a first stage of sourcing livestock from certified free range breeders. FIG. 27 illustrates collection of digital data during a second stage of moving the livestock from growing paddocks to grain finishing paddocks. The collection of digital data during the final stage of moving the livestock from grain finishing paddocks to processing plants is illustrated in FIG. 28.

### Example 14: Medical Marijuana

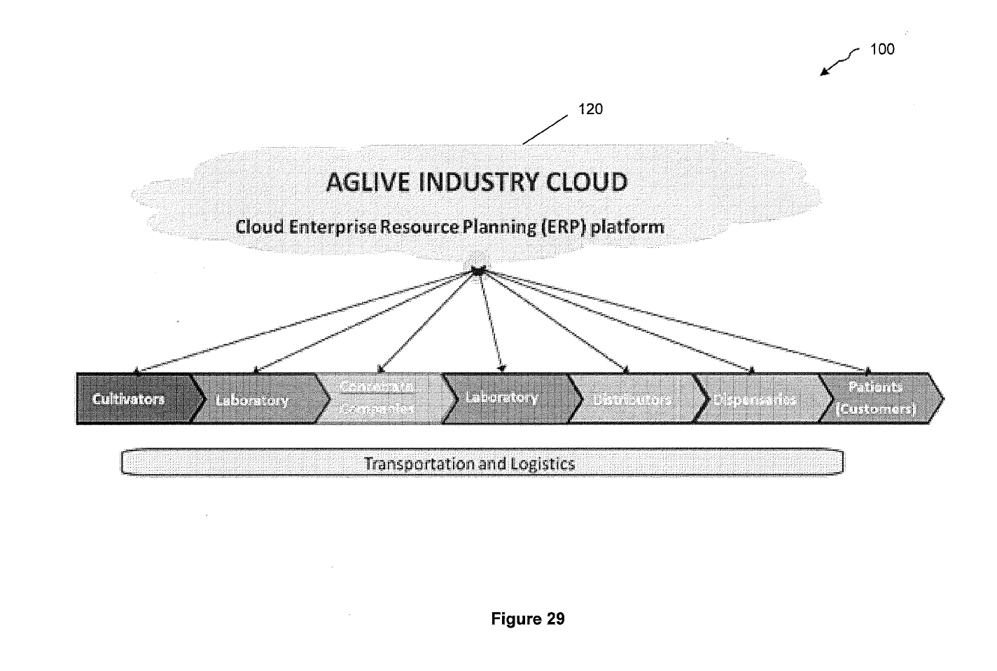

FIGS. 29 to 32 illustrate an example implementation of the system 100 and method 200 to provide a digital seed-to-sale track and trace platform for controlled substances, such as medical marijuana (or cannabis), industrial hemp and opium poppies. Digital data may be collected both outdoor and indoor using UWB chip location data during production, transport, packaging, storage and sale. The collected digital data may be aggregated into a digital data chain at the cloud data warehouse 120 and shared with all supply chain participants.

### Example 15: Grain Tracking

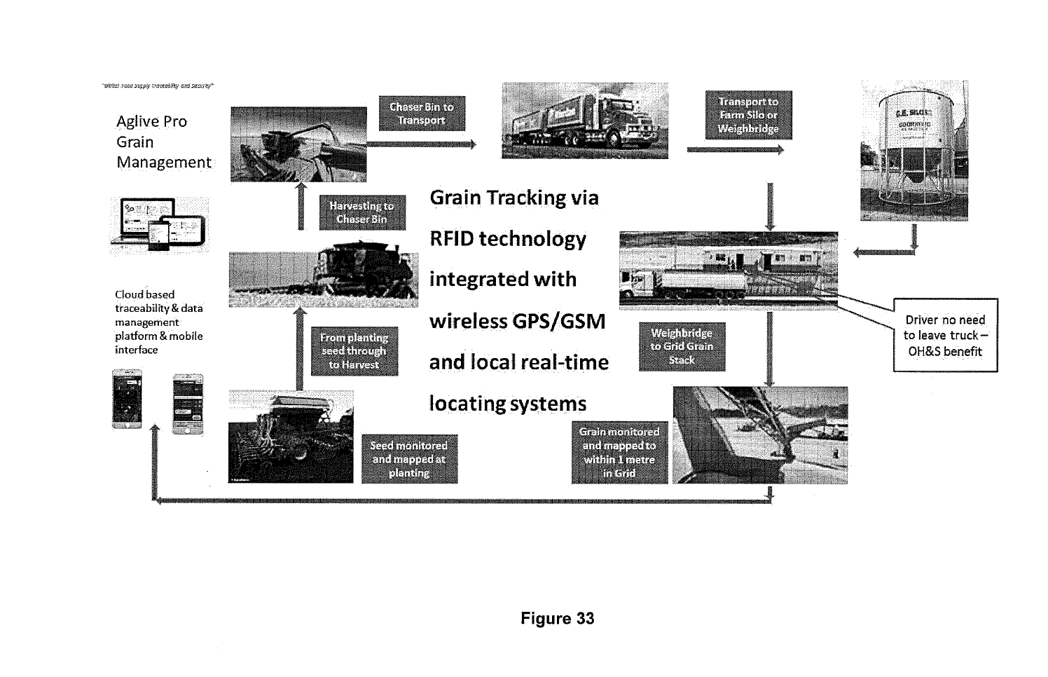

FIG. 33 illustrates an example implementation of the system 100 and method 200 to provide grain tracking using RFID technology integrated with wireless GPS/GSM and local real-time locating systems. The integration of digital data into a cloud data warehouse 120 enables it to be conveniently accessed by all supply chain participants. For example, grain truck drivers and weighbridge operators may electronically access and share digital data about vehicle weight, grain quality/grade, and grain weight remotely without physically leaving their vehicles or weighbridge stations.

### Example 16: Integrated Vehicle Tracking

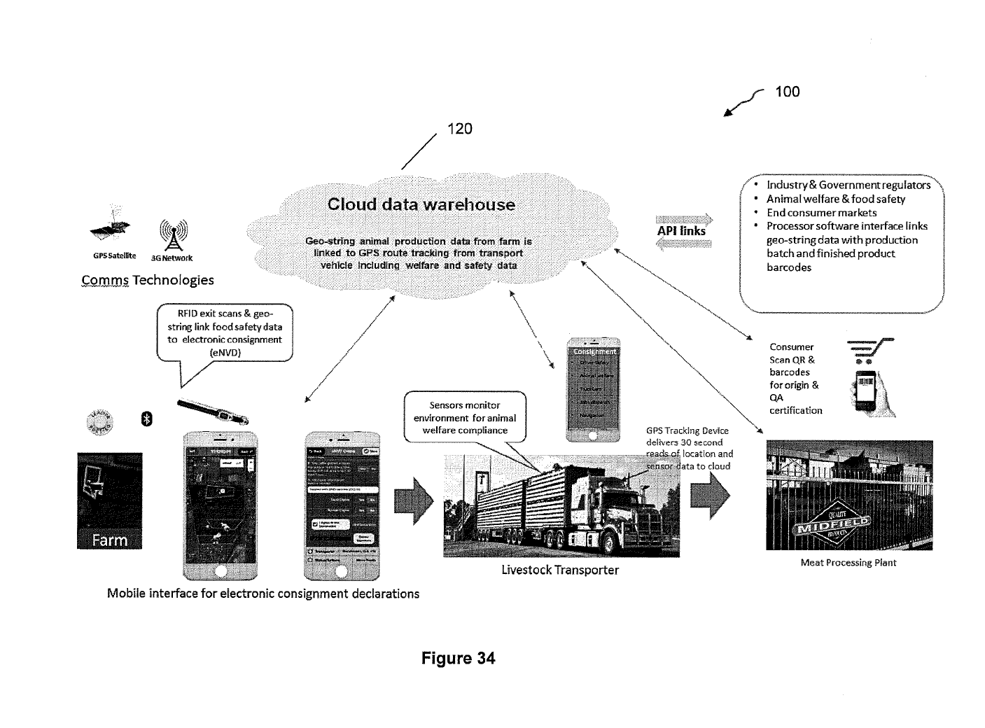

FIG. 34 illustrates an example implementation of the system 100 and method 200 that integrates vehicle tracking between nodes of physical supply chains. Digital data may be collected en route between nodes to supplement digital data collected at fixed nodes, such as farms and processing plants. The integration of digital data from vehicles into a cloud data warehouse 120 adds digital data about worker and driver safety, animal welfare and biosecurity to create a digital data chain that provides complete paddock-to-plate digital provenance verification and traceability.

Embodiments of the present invention provide a system and method that are useful for end-to-end digital supply chain traceability. Embodiments of the invention may advantageously be agnostic to, or independent from, any standardised data structures, software operating systems, protocols or formats that are specific to any particular types of materials in any particular types of physical supply chains in any particular industries or countries.

As used herein, the term “comprising” means “including but not limited to,” and the word “comprises” has a corresponding meaning.

The above embodiments have been described by way of example only and modifications are possible within the scope of the claims that follow.

1. A method, comprising:
receiving, by one or more computing devices, digital data about a physical object located at or between nodes in a physical supply chain, wherein the digital data is collected by and received from one or more digital devices without manual user-defined data input;
aggregating, by the one or more computing devices, the digital data into a digital data chain that is a digital representation of the physical object in the physical supply chain;
providing, by the one or more computing devices, access to the digital data chain to verify one or more attributes of the physical object.

2. The method of claim 1, further comprising tracking or tracing, by the one or more computing devices, the physical object along the physical supply chain in upstream and/or downstream directions based on the digital data chain.

3. The method of claim 1, further comprising managing, by the one or more computing devices, the physical supply chain of the physical object based on the digital data chain.

4. The method of claim 1, further comprising auditing, by the one or more computing devices, the physical supply chain to determine compliance or non-compliance of the physical object with regulations associated with the physical supply chain based on the digital data chain.

5. The method of claim 1, further comprising determining, by the one or more computing devices, a break in the physical supply chain of the physical object based on detecting a break in the digital data chain.

6. The method of claim 5, further comprising generating, by the one or more computing devices, a digital alert upon detecting the break in the digital data chain.

7. The method of claim 1, further comprising determining, by the one or more computing devices, an itinerary of the physical object along the physical supply chain, and detecting, by the one or more computing devices, a departure from the itinerary based on the digital data chain.

8. The method of claim 1, further comprising detecting, by the one or more computing devices, one or more of a delay, a diversion, a substitution, a tampering, a chemical change, an environmental change, a temperature change, an alteration, a contamination, an adulteration, a misuse, a mishandling, an undersupply, an oversupply, a theft, an under-production, an over-production, an overheating, and a counterfeiting of the physical object along the physical supply chain based on the digital data chain.

9. The method of claim 1, further comprising providing, by the one or more computing devices, a digital data snapshot of the physical object at or between each node in the physical supply chain based on the digital data chain.

10. The method of claim 1, wherein the digital data comprises objective digital data relating to properties, characteristics or attributes that are natural, unique or inherent in or to the physical object.

11. The method of claim 10, wherein the objective digital data comprises a digital fingerprint or certificate of location, quantity and quality of the physical object at or between each node in the physical supply chain.

12. The method of claim 10, wherein the objective digital data has a standardised data structure, protocol or format that is independent of any standardised data structure, protocol or format associated with the physical object or the physical supply chain.

13. The method of claim 12, wherein the objective digital data has a data structure, protocol or format that is standardised at the level of the one or more digital devices.

14. The method of claim 12, wherein the objective digital data comprises at least both of a time and an associated geographic location, and at least one of a unique identifier, an electronic identification number, an International Mobile Equipment Identity (IMEI) number, a radio frequency identification (RFID) number, a Property Identification Code (PIC), a serial number, a barcode, a Quick Response (QR) code, an alpha and/or numeric code, a Global Positioning System (GPS) signal, GPS journey data, a consignment note barcode, a waybill barcode, Geographic Information System (GIS) data, a nutritional composition, an elemental composition, a molecular composition, quantity, weight, volume, mass, density, age, health, a digital image, a blood profile, a drug profile, a drug test result, a genetic profile, a DNA profile, a chemical signature, a biochemical signature, a physical signature, a magnetic signature, an electrical signature, an optical signature, a luminescent signature, an infrared signature, an ultraviolet signature, a temperature, a humidity, a light reflectivity or absorption, an acoustic signature, a colour profile, an altitude, a geo-fence, and combinations thereof.

15. The method of claim 14, wherein the objective digital data comprises at least both of a geolocation and an associated timestamp, at least one of a RFID number and an IMEI number, at least one of a PIC and a barcode, and at least one of a weight and a quantity.

16. The method of claim 1, further comprising receiving, by the one or more computing devices, user-defined data associated with the physical object at or between each node in the physical supply chain, and associating, by the one or more computing devices, the user-defined data with the objective digital data in the digital data chain.

17. The method of claim 1, wherein the physical object comprises one or more of a raw material, an intermediate material or product, a processed material, an article, a product, a component material or part, a comestible, an animal or livestock, a group of animals or livestock, hopps, grain, forestry products, a metal, a gem, a perishable good, a dangerous or hazardous good, an agricultural or industrial commodity, a luxury good or product, a structure, apparel, a consumer good or product, an electrical circuit or component, a weapon, an explosive, a fertiliser, an agrichemical, an industrial chemical, a pharmaceutical, a drug, an alcohol, a fuel, timber, tobacco, a food, a beverage, a controlled or regulated substance, cannabis, opium, free-range eggs, and transformations, mixtures and combinations thereof.

18. The method of claim 1, wherein the physical supply chain comprises a livestock supply chain, a meat supply chain, a seafood or aquaculture supply chain, a horticultural supply chain, a viticultural supply chain, a feedstock supply chain, a grain supply chain, a hopps supply chain, a tobacco supply chain, a forestry product supply chain, a cannabis supply chain, an opium supply chain, a free-range egg supply chain, and combinations thereof.

19. The method of claim 1, wherein the one or more digital devices comprise one or more of a RFID tag, a write-once RFID tag, a RFID reader, an ultra-high frequency (UHF) tag, an ultra-wideband (UWB) radio transceiver/repeater chip, a sensor supplied or integrated with a label or packaging, an electronic identification device (EID), a barcode scanner, a lab on a chip (LOC), a GPS receiver, a microfluidic device, a drug testing device, a digital weighing scale, a molecular sensor, a health sensor, a digital camera, an optical sensor, a temperature sensor, a humidity sensor, a portable or handheld spectrometer, an acoustic sensor, a mobile computing device, a smartphone, a tablet, a laptop computer, and combinations thereof.

20. A computer program product comprising a non-transitory computer usable medium including a computer readable program, wherein the computer readable program when executed on a computer causes the computer to:
receive digital data about a physical object located at or between nodes in a physical supply chain, wherein the digital data is collected by and received from one or more digital devices without manual user-defined data input;
aggregate the digital data into a digital data chain that is a digital representation of the physical object in the physical supply chain;
provide access to the digital data chain to verify one or more attributes of the physical object.
